(19) United States
(12) Patent Application Publication
(10) Pub. No.: US 2026/0175174 A1
(43) Pub. Date: Jun. 25, 2026

(54) TIDAL ENERGY CONVERTER APPARATUS

(71) Applicants: MEHRDAD GOLBARG, TEHRAN (IR); ARIAN GOLBARG, TEHRAN (IR)

(72) Inventors: MEHRDAD GOLBARG, TEHRAN (IR); ARIAN GOLBARG, TEHRAN (IR)

(21) Appl. No.: 19/400,419

(22) Filed: Nov. 25, 2025

Related U.S. Application Data
(63) Continuation-in-part of application No. PCT/IB2023/058339, filed on Aug. 22, 2023.

(51) Int. Cl. B01D 61/08; B01D 61/02; B01D 61/12; B63B 35/44

(52) U.S. Cl. CPC B01D 61/08; B01D 61/025; B01D 61/12; B63B 35/44

(57) ABSTRACT

In accordance with some embodiments herein, an apparatus is provided. The apparatus includes a buoyant body configured to float on a body of water, a weighted structure, a weighted structure support assembly and a cylinder assembly. The weighted structure support assembly includes a lock mechanism and a release mechanism. The cylinder assembly includes a cylinder housing and a piston in the cylinder housing. The cylinder housing defines one or more fluid inlets and one or more fluid outlets. Movement of the buoyant body, induced by the rising and falling of water levels of the body of water, allows the piston to move within the cylinder housing. Movement of the piston within the cylinder housing allows a first fluid to enter the cylinder housing through the one or more fluid inlets and allows a second fluid to exit the cylinder housing through the one or more fluid outlets.

### RELATED APPLICATION

This application claims priority to and is a continuation-in-part of International Application Number PCT/IB2023/058339, filed on Aug. 22, 2023, entitled “TIDAL ENERGY CONVERTER SYSTEM FOR PRODUCING PRESSURISED FLOW”, which is incorporated herein by reference in its entirety.

### TECHNICAL FIELD

The present disclosure relates generally to systems that convert the motion of a body of water into energy suitable for use in power generation, desalination, or other fluid-processing applications.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In some embodiments, an apparatus is provided. The apparatus includes a buoyant body, a weighted structure, a weighted structure support assembly and a cylinder assembly. The buoyant body is configured to float on a body of water. The weighted structure support assembly includes a lock mechanism and a release mechanism. The cylinder assembly includes a cylinder housing and a piston in the cylinder housing. The cylinder housing defines a first chamber on a first side of the piston and a second chamber on a second side of the piston. The cylinder housing defines a fluid inlet fluidly connected to the first chamber and a fluid outlet fluidly connected to the first chamber. The piston is coupled to the weighted structure. Upward movement of a surface of the body of water induces upward movement of the buoyant body from a first buoyant body elevation to a second buoyant body elevation. The upward movement of the buoyant body from the first buoyant body elevation to the second buoyant body elevation induces upward movement of the weighted structure from a first weighted structure elevation to a second weighted structure elevation. The upward movement of the weighted structure from the first weighted structure elevation to the second weighted structure elevation induces a first movement of the piston in a first direction. The first movement of the piston induces transfer of a fluid from a fluid source into the first chamber through the fluid inlet. The lock mechanism engages the weighted structure to support the weighted structure at the second weighted structure elevation in response to the weighted structure reaching the second weighted structure elevation. Downward movement of the surface of the body of water induces downward movement of the buoyant body from the second buoyant body elevation to the first buoyant body elevation. During the downward movement of the buoyant body from the second buoyant body elevation to the first buoyant body elevation, the buoyant body engages the release mechanism. The engagement of the buoyant body with the release mechanism disengages the lock mechanism from the weighted structure to allow downward movement of the weighted structure from the second buoyant body elevation to the first buoyant body elevation. The downward movement of the weighted structure induces a second movement of the piston in a second direction different than the first direction. The second movement of the piston induces transfer of the fluid from the first chamber to outside the first chamber through the fluid outlet.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1D illustrate sequential stages of an operational cycle of an apparatus during the rising and falling of a body of water, in accordance with some embodiments.

FIG. 1E illustrates a top view of an apparatus, in accordance with some embodiments.

FIGS. 1F-1K illustrate first cross-sectional views of sequential stages of an operational cycle of an apparatus during the rising and falling of water levels of a body of water, in accordance with some embodiments.

FIGS. 1L-1Q illustrate second cross-sectional views of sequential stages of an operational cycle of an apparatus during the rising and falling of water levels of a body of water, in accordance with some embodiments.

FIG. 2A illustrates an enlarged and/or detailed view of a section of an apparatus, in accordance with some embodiments.

FIG. 2B illustrates an enlarged and/or detailed view of a section of an apparatus, in accordance with some embodiments.

FIG. 2C illustrates an enlarged and/or detailed view of a section of an apparatus, in accordance with some embodiments.

FIG. 2D illustrates an enlarged and/or detailed view of a section of an apparatus, in accordance with some embodiments.

FIG. 2E illustrates an enlarged and/or detailed view of a section of an apparatus, in accordance with some embodiments.

FIG. 2F illustrates an enlarged and/or detailed view of a section of an apparatus, in accordance with some embodiments.

FIG. 2G illustrates a schematic view of a first weighted structure support assembly at a first stage of an operational cycle of an apparatus at the beginning of rising of a body of water, in accordance with some embodiments.

FIG. 2H illustrates a schematic view of a first weighted structure support assembly at a second stage of an operational cycle of an apparatus at the end of rising of a body of water, in accordance with some embodiments.

FIG. 2I illustrates a schematic view of a first weighted structure support assembly at a third stage of an operational cycle of an apparatus approaching the end of falling of a body of water, in accordance with some embodiments.

FIG. 2J illustrates a schematic view of a first weighted structure support assembly at a fourth stage of an operational cycle of an apparatus at the end of the falling of a body of water and/or at the beginning of second rising of the body of water, in accordance with some embodiments.

FIGS. 3A-3D illustrate a desalination system comprising an apparatus, a buffer pressure tank, a membrane assembly and a storage tank, in accordance with some embodiments.

FIG. 4 illustrates a desalination system comprising an apparatus, a fluid source storage tank, a membrane assembly and a storage tank, in accordance with some embodiments.

FIG. 5A illustrates a representation of a side view of a plurality of tidal energy converter apparatuses, in accordance with some embodiments.

FIG. 5B illustrates a representation of a top view of a plurality of tidal energy converter apparatuses, in accordance with some embodiments.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative.

The utilization of renewable energy sources has gained significant attention as an alternative to fossil fuel-based power generation. Among various renewable energy resources, the motion of water bodies, such as waves and tides, presents an abundant and predictable source of mechanical energy that can be harnessed for electricity generation, fluid pumping, and other useful applications. Conventional wave and tidal energy conversion devices often rely on complex mechanical linkages, turbines, or rotary-to-linear conversion systems that are subject to high manufacturing costs, mechanical inefficiencies, and maintenance challenges due to exposure to harsh marine environments. Many existing systems also fail to provide efficient energy capture from the vertical displacement of water surfaces or require bulky infrastructure anchored to the seabed. There remains a need for a reliable, cost-effective, and mechanically simplified apparatus that can directly convert the vertical movement of a buoyant body, induced by wave or tidal fluctuations, into useful mechanical energy. The present disclosure addresses these shortcomings by providing an apparatus comprising the buoyant body, a weighted structure, a support assembly with lock and release mechanisms, and a piston-cylinder assembly configured to pump or transfer fluid in response to water surface motion.

The rising and falling of ocean or sea water levels, which is called tidal phenomenon, often happens at regular predictable daily cycles. In some coastal regions, the height difference between rising wave (e.g., high tide) and falling wave (e.g., low tide) is high enough to produce considerable energy. The considerable energy may be harnessed and converted to many kinds of energies such as electricity, which may in turn be used to perform actions such as producing fresh water.

Various systems and methods are used to desalinate and purify saltwater water (e.g., untreated ocean or sea water) for producing fresh water, among which membrane desalination systems such as reverse osmosis are commonly used. In the membrane desalination systems, it is necessary to introduce high-pressure flow of the untreated water into the system so that a filtration and purification may be performed properly by membranes embedded in the system. For producing high-pressure flow of untreated water, electrical pumps may be used in the systems. For the purpose of supplying required energy for pumps and other equipment, tidal energy may be converted to electrical energy in order to apply pressure to the untreated water.

Using electricity or fossil fuels to supply the required energy in water desalination and filtration systems, may involve a series of disadvantages including, for example, financial costs and environmental damages and so on. In addition, the maintenance of numerous equipment used in the systems will be costly and time-consuming. Therefore, there is a need for new systems comprising fewer components that are capable of producing high-pressure flow by directly using tidal energy.

Many tide-or wave-powered devices struggle to convert the natural rise and fall of water levels into steady hydraulic output. A major limitation of existing systems is that they typically produce useful motion only during the upward movement of the water. When the water level drops, the driving components often reverse direction or simply lose effectiveness, wasting much (e.g., half) of the available energy. Other devices attempt to solve this using complicated valves, gear trains, or pressure-storage components, which increases mechanical complexity, reduces reliability, and requires frequent maintenance. Another problem is the difficulty of incorporating a heavy load into the system in a controlled way. Weight-assisted mechanisms can, in theory, boost hydraulic output, but in practice the safety systems that hold and release the weight often jam, wear out, or release at the wrong moment. As a result, current technologies struggle to maintain smooth and predictable pressurization needed for desalination, power generation, or long-distance fluid transfer.

The present disclosure introduces an apparatus that provides a simplified and robust solution to these issues by coordinating the motion of a floating body with a suspended weight through an automatic lock-and-release arrangement. Overall, the disclosed apparatus solves long-standing problems in wave-and tide-driven systems by (i) extracting energy from both the rising and falling phases of the water cycle, rather than just one of the phases (e.g., the rising phase), (ii) using a simple, durable, and dependable lock-and-release mechanism instead of complicated mechanical linkages prone to failure, and/or (iii) producing steady, high-pressure flow suitable for desalination, electricity generation, or other applications requiring consistent fluid output.

The present disclosure accomplishes energy extraction from both the rising and falling phases of the water cycle by using the natural vertical motion of a floating element to lift a heavy mass during the upward movement of the water and then holding that elevated mass at the top. When the water level later drops, the system automatically releases the held mass so that it descends under its own weight, driving the working component again in the opposite direction. In this way, the system captures useful mechanical work during both the ascent of the water (when the floating element rises) and the descent of the water (when the stored weight falls) thereby utilizing the full tidal cycle rather than only one half of it.

The present disclosure achieves a simple, durable, and dependable lock-and-release function by employing straightforward mechanical parts that move in predictable ways, rather than relying on intricate assemblies and/or sensitive components. The locking action is performed by a basic support element that holds the elevated mass securely, while the release action is triggered by a direct interaction with the floating element, eliminating the need for sensors, electronics, and/or complex timing systems. The motion is transferred through only a few robust pieces that pivot or slide, minimizing wear points and reducing the likelihood of malfunction. Because the mechanism depends on gravity, leverage, and uncomplicated physical contact, it remains reliable even in harsh marine environments and requires far less maintenance than more elaborate mechanical linkages.

The present disclosure produces a steady, high-pressure fluid output by using the controlled downward force of a suspended mass to drive a pumping element with predictable and consistent power. After the mass is lifted by the rising water and then securely held in place, its release allows it to descend smoothly and apply a strong, uniform pushing action on the working chamber. Because this force is generated by gravity rather than irregular wave motion, the pressure produced is stable and repeatable. In addition, the system can draw in fresh fluid during one part of the cycle and discharge it under pressure during another, creating a continuous sequence of intake and output events. This combination of a reliable driving force and a repeating pump cycle results in a controlled, high-pressure flow that is well-suited for processes such as desalination, power generation, or any application that depends on consistent hydraulic performance.

The present disclosure provides an apparatus. In some examples, the apparatus may comprise a buoyant body, a weighted structure, a weighted structure support assembly and/or a cylinder assembly. In some examples, the buoyant body may be configured to float on a body of water. In some examples, the weighted structure support assembly may comprise a lock mechanism and a release mechanism. In some examples the cylinder assembly may comprise a cylinder housing and a piston in the cylinder housing. In some examples, the cylinder housing may define a first chamber on a first side of the piston and a second chamber on a second side of the piston. In some examples, the cylinder housing may define a fluid inlet fluidly connected to the first chamber and a fluid outlet fluidly connected to the first chamber. In some examples, the piston may be coupled to the weighted structure.

In some examples, upward movement of a surface of the body of water may induce upward movement of the buoyant body from a first buoyant body elevation to a second buoyant body elevation. Alternatively and/or additionally, the upward movement of the buoyant body from the first buoyant body elevation to the second buoyant body elevation may induce upward movement of the weighted structure from a first weighted structure elevation to a second weighted structure elevation. Alternatively and/or additionally, the upward movement of the weighted structure from the first weighted structure elevation to the second weighted structure elevation may induce a first movement of the piston in a first direction. Alternatively and/or additionally, the first movement of the piston may induce a transfer of a fluid from a fluid source into the first chamber through the fluid inlet.

In some examples, the lock mechanism may engage the weighted structure to support the weighted structure at the second weighted structure elevation in response to the weighted structure reaching the second weighted structure elevation. In some examples, downward movement of the surface of the body of water may induce downward movement of the buoyant body from the second buoyant body elevation to the first buoyant body elevation. In some examples, during the downward movement of the buoyant body from the second buoyant body elevation to the first buoyant body elevation, the buoyant body may engage the release mechanism. In some examples, the engagement of the buoyant body with the release mechanism may disengage the lock mechanism from the weighted structure to allow downward movement of the weighted structure from the second buoyant body elevation to the first buoyant body elevation. Alternatively and/or additionally, the downward movement of the weighted structure may induce second movement of the piston in a second direction different than the first direction. Alternatively and/or additionally, the second movement of the piston may induce a transfer of the fluid from the first chamber to outside the first chamber through the fluid outlet.

In some examples, the cylinder housing may define a second fluid inlet fluidly connected to the second chamber and a second fluid outlet fluidly connected to the second chamber. In some examples, the second movement of the piston induced by the downward movement of the weighted structure may induce a transfer of a second fluid from the fluid source into the second chamber through the second fluid inlet. Alternatively and/or additionally, the second upward movement of the surface of the body of water may induce second upward movement of the buoyant body from the first buoyant body elevation to the second buoyant body elevation. Alternatively and/or additionally, the second upward movement of the buoyant body from the first buoyant body elevation to the second buoyant body elevation may induce second upward movement of the weighted structure from the first weighted structure elevation to the second weighted structure elevation. Alternatively and/or additionally, the second upward movement of the weighted structure from the first weighted structure elevation to the second weighted structure elevation induces third movement of the piston in the first direction. Alternatively and/or additionally, the third movement of the piston may induce a transfer of the second fluid from the second chamber to outside the second chamber through the second fluid outlet. Alternatively and/or additionally, the third movement of the piston may induce a transfer of a third fluid from the fluid source into the first chamber through the fluid inlet.

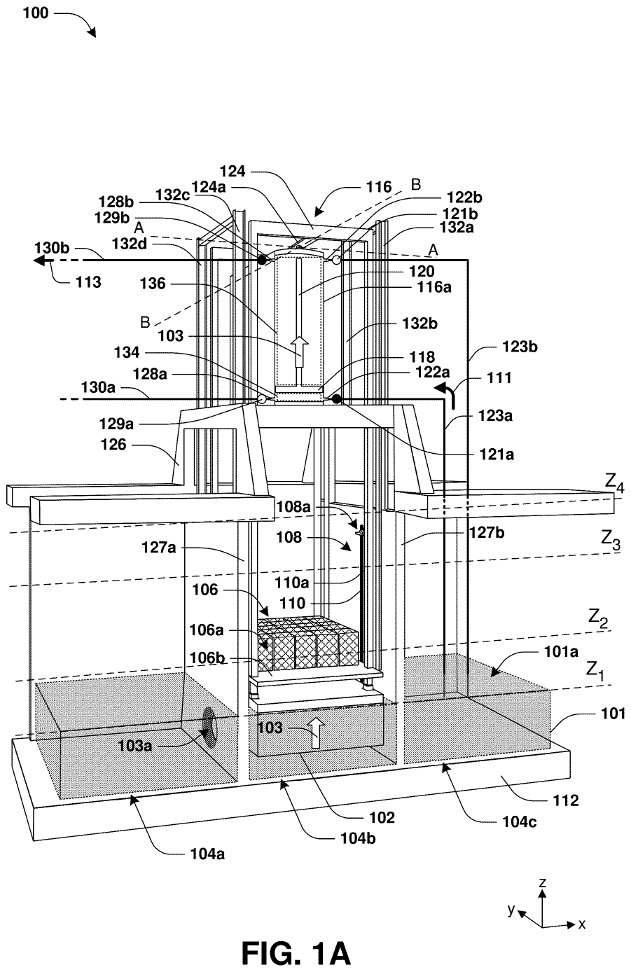

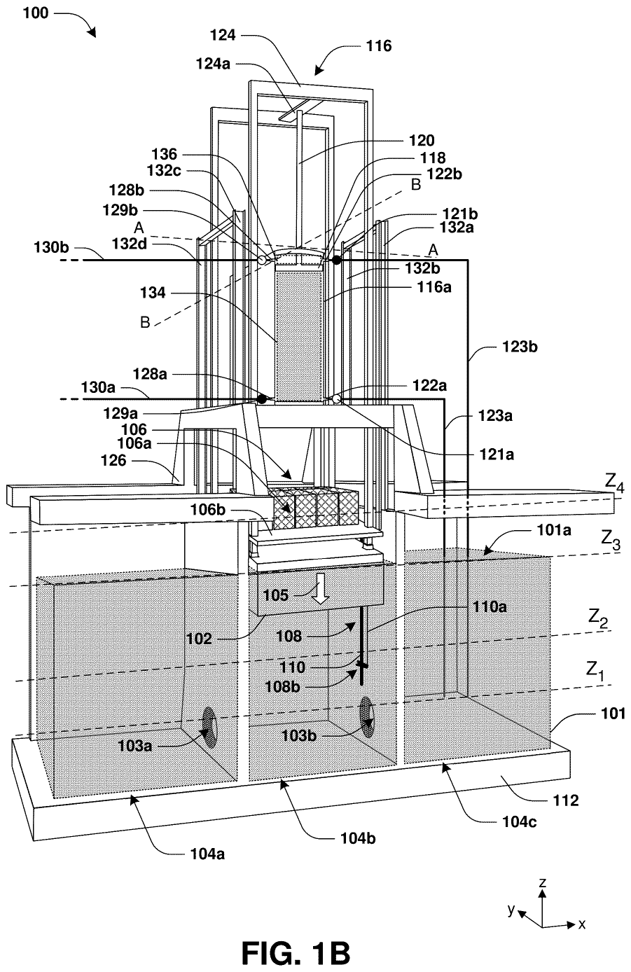

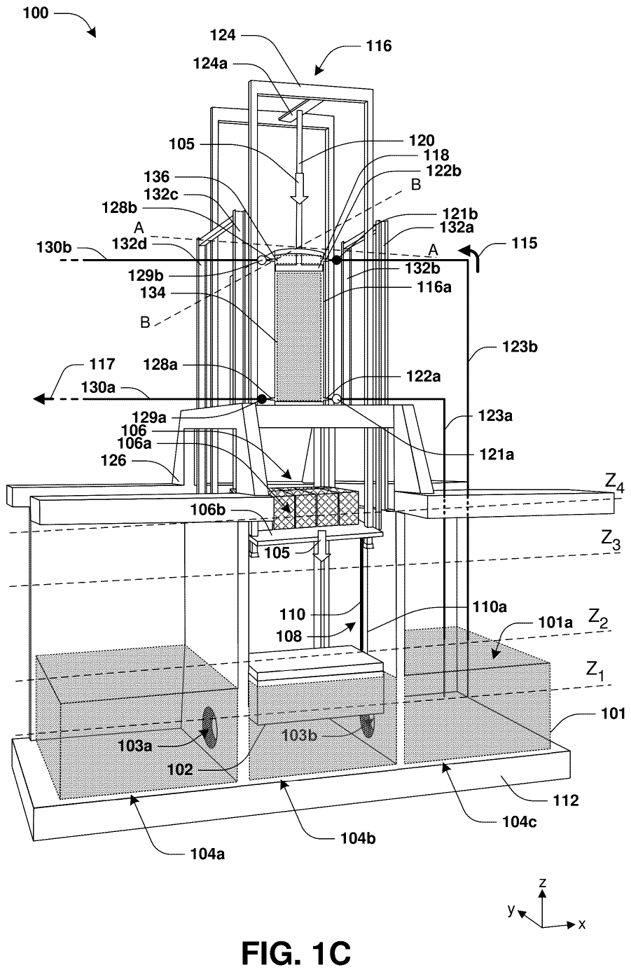

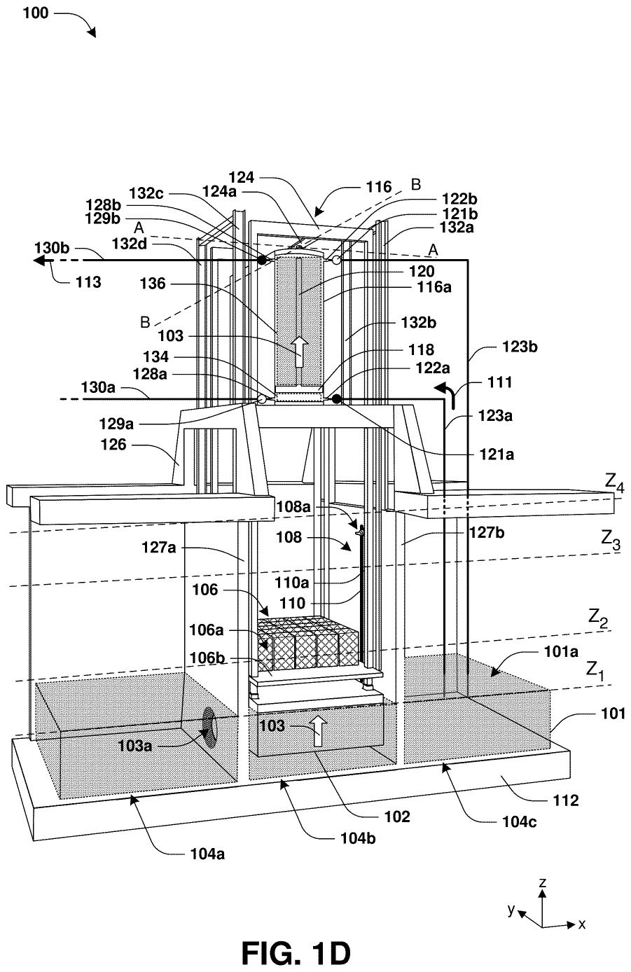

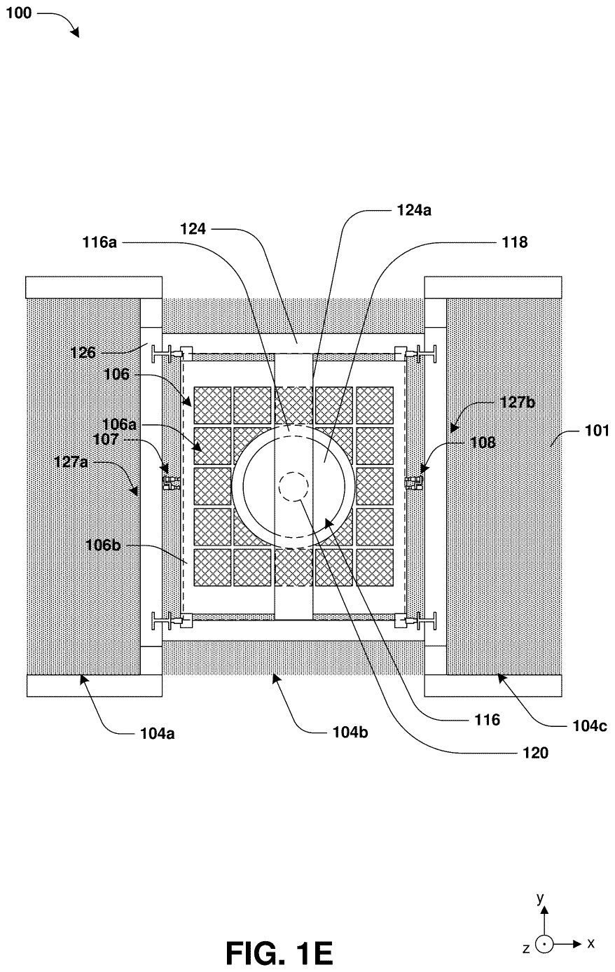

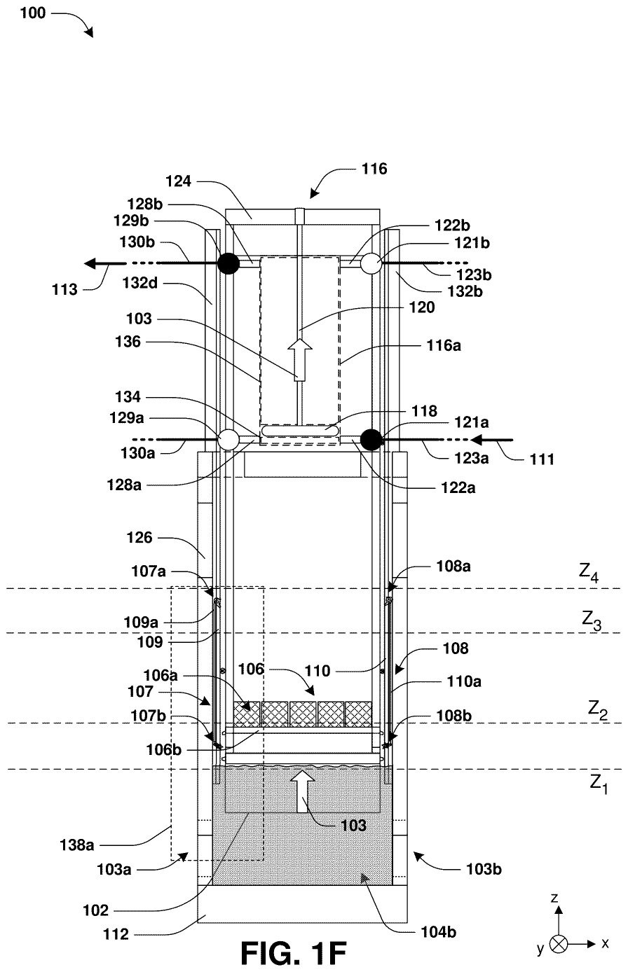

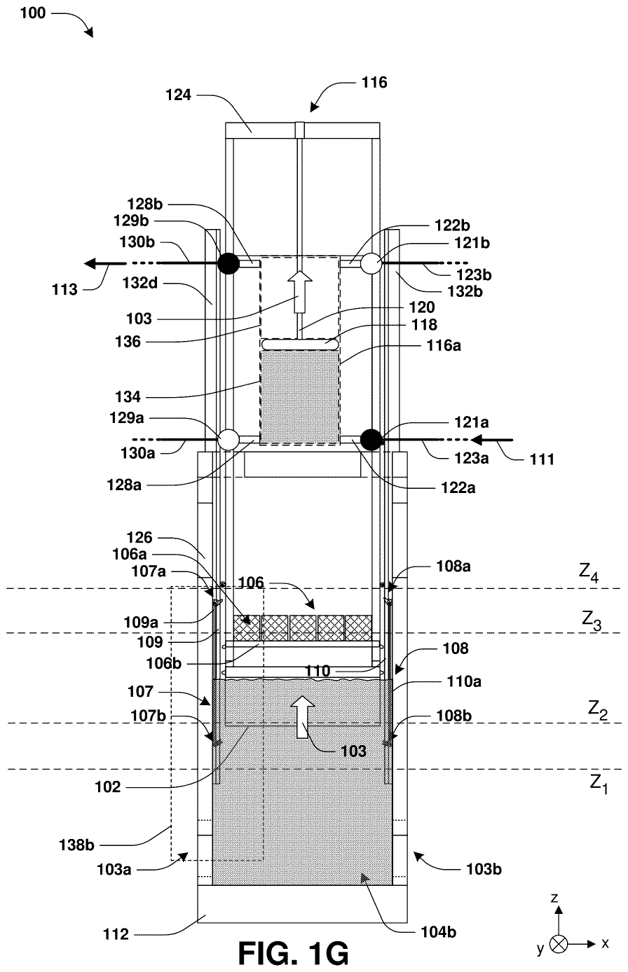

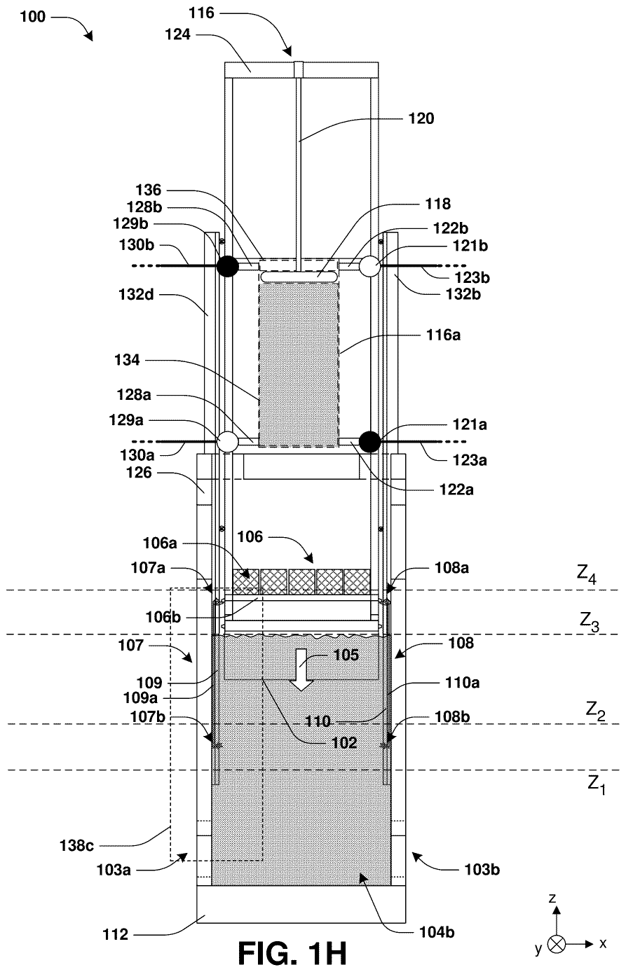

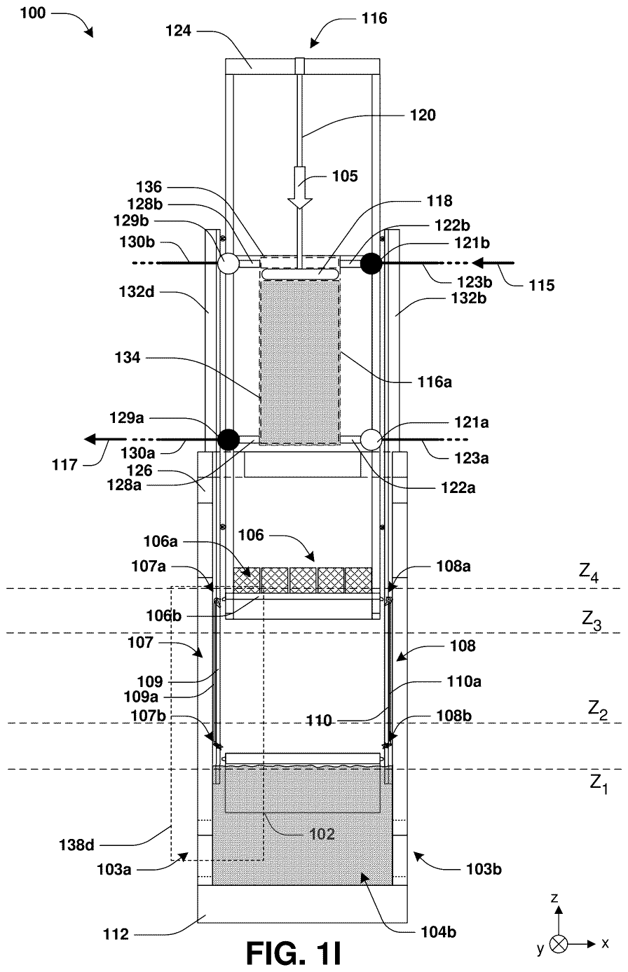

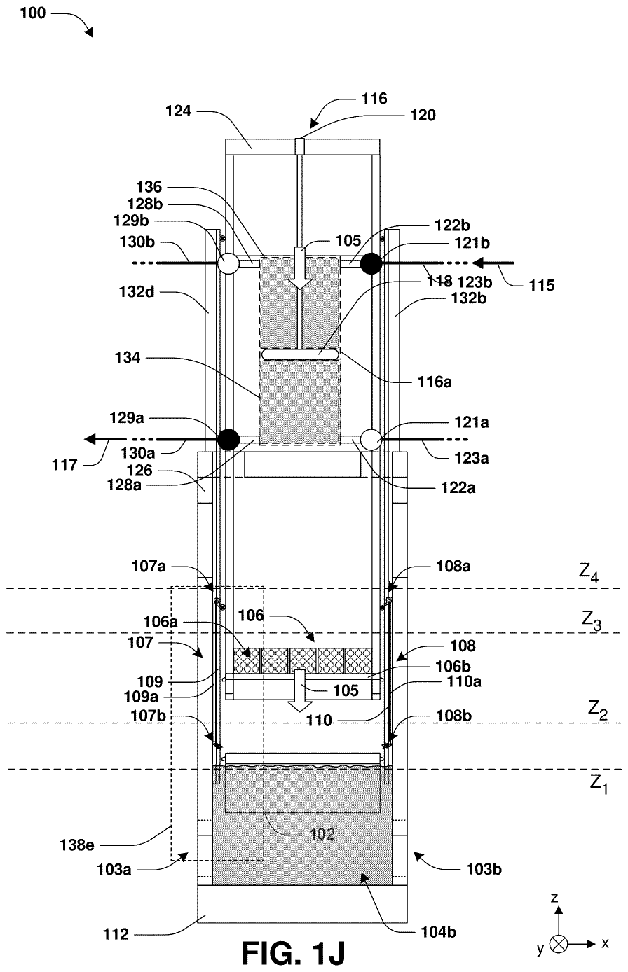

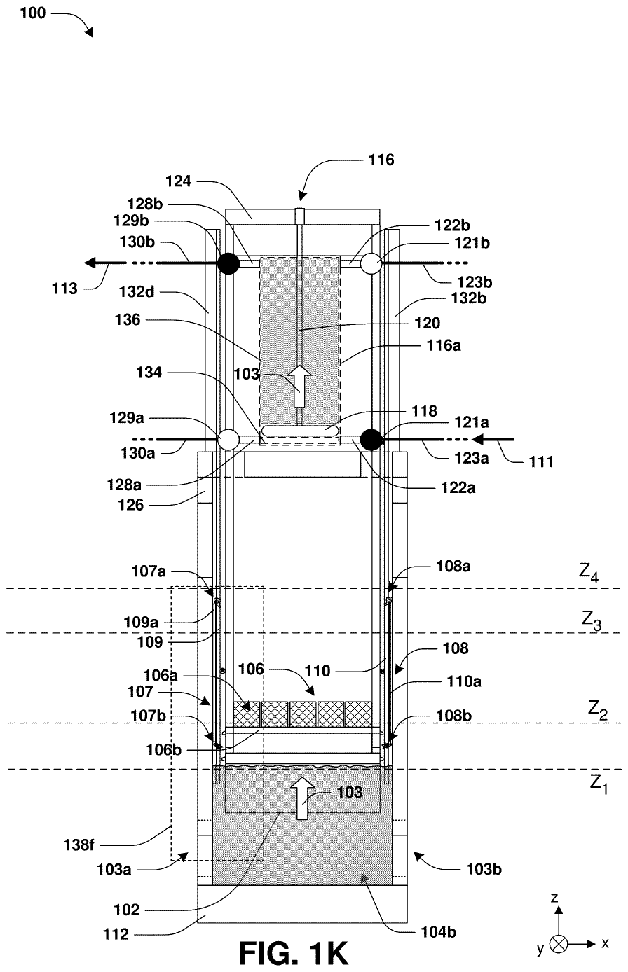

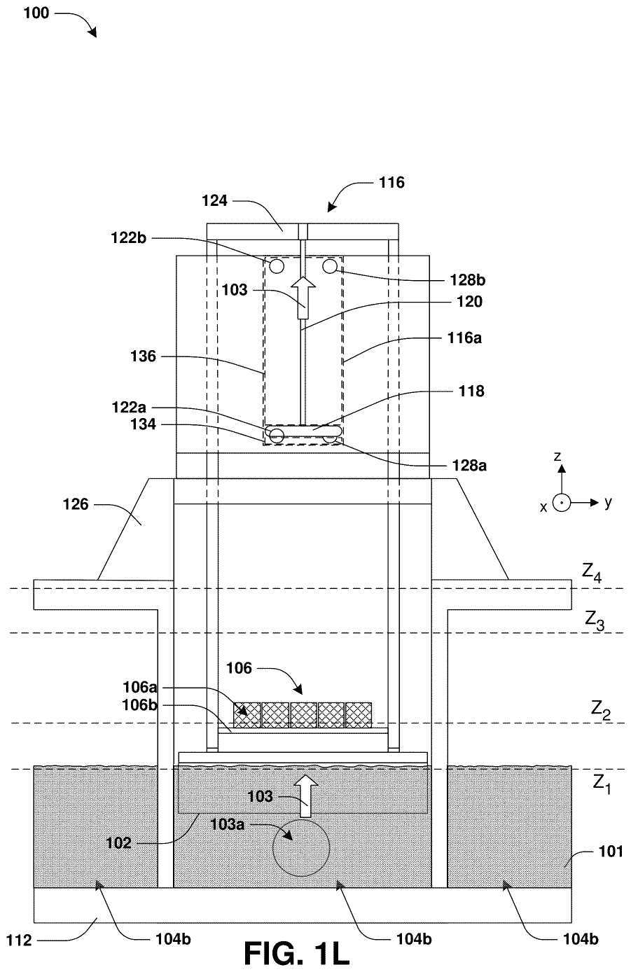

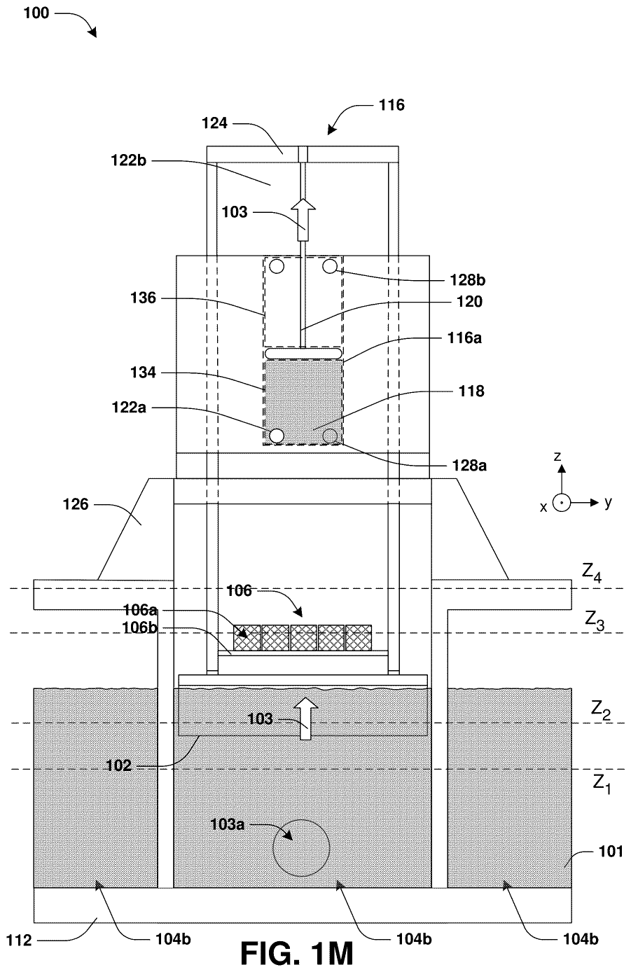

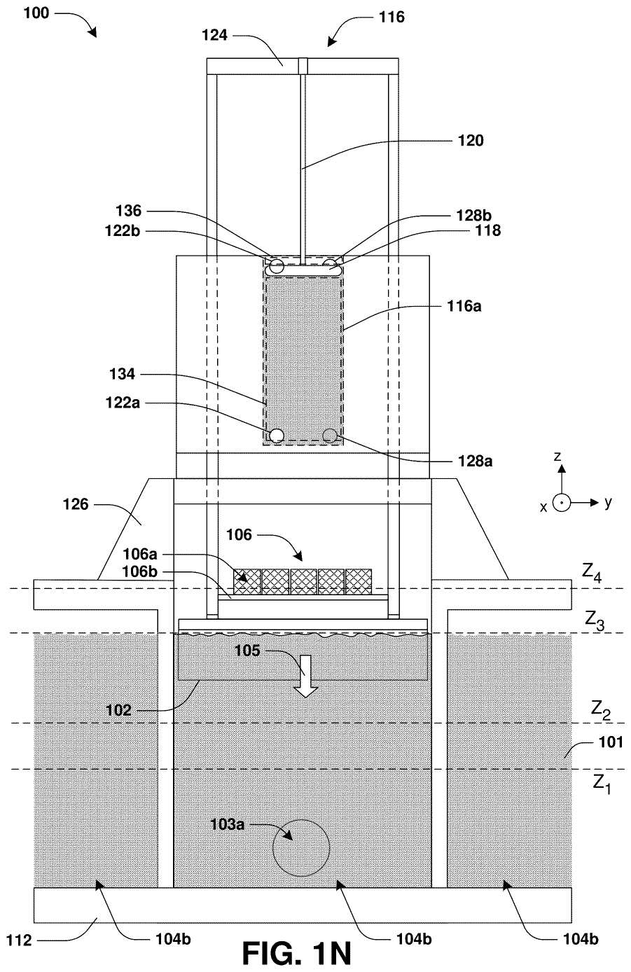

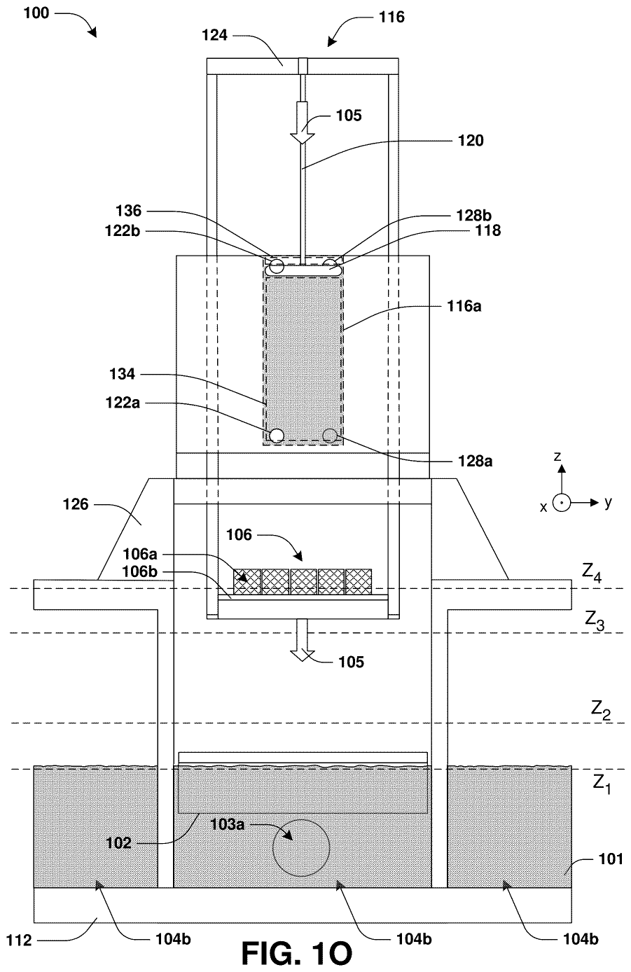

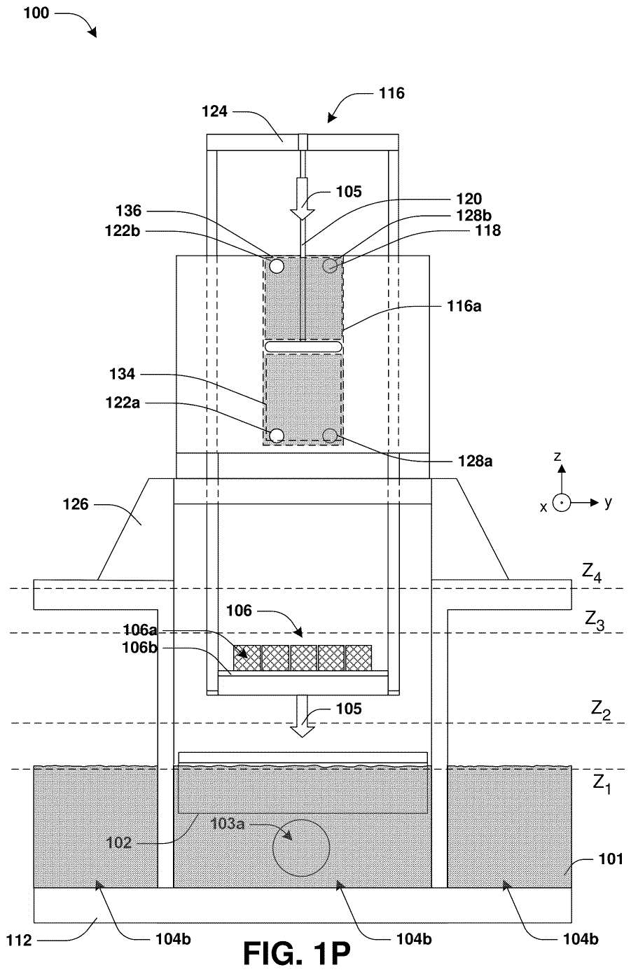

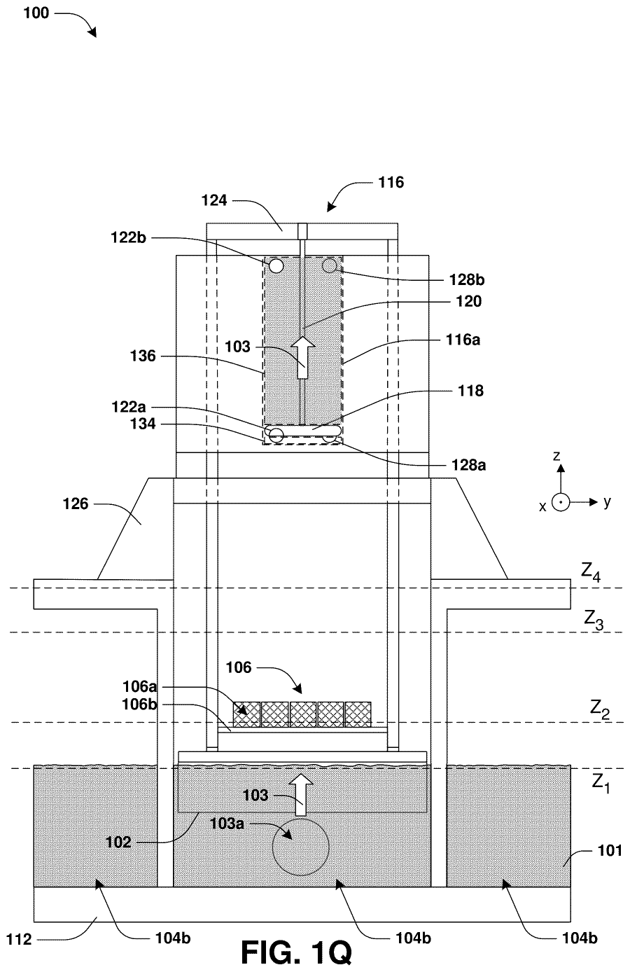

FIGS. 1A-1D illustrate sequential stages of an operational cycle (e.g., a functional cycle, etc.) of an apparatus 100 (e.g., an energy convertor apparatus, a tidal energy converter apparatus, etc.) during the rising and falling of water levels of a body of water 101 (e.g., comprising ocean water, sea water, untreated water, etc.) (e.g., during a rising tide phase of the body of water 101 and a falling tide phase of the body of water 101), in accordance with some embodiments. FIG. 1A illustrates a first stage (e.g., an initial stage) of the operational cycle of the apparatus 100 at the beginning of the rising of the body of water 101 (e.g., rising water level, the rising tide phase of the body of water 101), in accordance with some embodiments. FIG. 1B illustrates a second stage of the operational cycle of the apparatus 100 at the end of the rising of the body of water 101 and/or at the beginning of the falling of the body of water 101 (e.g., falling water level, the falling tide phase of the body of water 101), in accordance with some embodiments. FIG. 1C illustrates a third stage of the operational cycle of the apparatus 100 approaching the end of the falling of the body of water 101, in accordance with some embodiments. FIG. 1D illustrates a fourth stage (e.g., a final stage) of the operational cycle of the apparatus 100 at the end of the falling of the body of water 101 and/or at the beginning of a second rising of the body of water 101 (e.g., a second rising water level, a second rising tide phase of the body of water 101), in accordance with some embodiments. In some examples, the apparatus 100 may be positioned proximal coastal regions and/or may be disposed over a second body of water (e.g., a pool) to which the body of water 101 may be introduced.

In some examples, the apparatus 100 is configured to operate during both the rising and the falling of the body of water 101. Each complete cycle of operation associated with the apparatus 100 may correspond to a rising phase of the body of water 101 followed by a falling phase of the body of water 101. For example, the operational cycle may begin at the initial stage when the body of water 101 starts to rise, continue through the rising phase, proceed through the subsequent falling phase, and conclude at the end of the falling phase. Each such sequence of the rising and falling of water levels of the body of water 101 may constitute one full operational cycle of the apparatus 100. The operational cycle may then repeat with the subsequent rising and falling of water levels of the body of water 101, thereby enabling the apparatus 100 to continuously operate and/or convert energy during tidal phases.

In some examples, the apparatus 100 may comprise a buoyant body 102 (e.g., a floating body, a buoyancy member, a floatable structure, etc.) configured to float on the body of water 101. In some examples, the buoyant body 102 may comprise one or more protrusions (e.g., one or more projections, one or more ridges, one or more fingers, a first protrusion, a second protrusion, etc.).

In some examples, the apparatus 100 may comprise a weighted structure 106, wherein the weighted structure 106 may comprise one or more weights 106a and/or a support surface 106b (e.g., a shelf, a platform, a base element, etc.) configured to support (e.g., bear, carry, etc.) the one or more weights 106a. In some examples, the support surface 106b may comprise one or more second protrusions (e.g., one or more second projections, one or more second ridges, one or more second fingers, a third protrusion, a fourth protrusion, etc.). In some examples, the support surface 106b may be coupled (e.g., attached, connected, etc.) to one or more legs of a frame 124. In some examples, each leg of the one or more legs may comprise one or more sliders (e.g., one or more wheels, one or more roller bearings, etc.) configured to slide (e.g., move slidably, etc.) on one or more guide rails (e.g., a first guide rail 132c, a second guide rail 132d, a third guide rail 132a, a fourth guide rail 132b, etc.).

In some examples, the apparatus 100 may comprise one or more weighted structure support assemblies (e.g., a first weighted structure support assembly, a second weighted structure support assembly 108). Each weighted structure support assembly of the one or more weighted structure support assemblies may comprise a lock mechanism, a release mechanism, a connecting rod and/or a detent. For example, the first weighted structure support assembly may comprise a first lock mechanism, a first release mechanism, a first connecting rod and/or a first detent. For example, the second weighted structure support assembly 108 may comprise a second lock mechanism 108a, a second release mechanism 108b, a second connecting rod 110a and/or a second detent (not shown).

In some examples, the first release mechanism may comprise a first crank coupled (e.g., connected, attached, etc.) to a first support column via a first fulcrum (e.g., a first pivot). In some examples, the first lock mechanism may comprise a first latch coupled (e.g., connected, attached, etc.) to the first support column via a second fulcrum (e.g., a second pivot).

In some examples, the second release mechanism 108b may comprise a second crank coupled (e.g., connected, attached, etc.) to a second support column 110 via a third fulcrum (e.g., a third pivot). In some examples, the second lock mechanism 108a may comprise a second latch coupled (e.g., connected, attached, etc.) to the second support column 110 via a fourth fulcrum (e.g., a fourth pivot).

In some examples, the apparatus 100 may comprise a cylinder assembly 116, wherein the cylinder assembly 116 may comprise a cylinder housing 116a, a piston 118 in the cylinder housing 116a and/or a piston rod 120. In some examples, a mass of the weighted structure 106 may be calculated (e.g., determined, defined, etc.) based upon a chamber volume associated with the cylinder housing 116a. In some examples, the cylinder housing 116a may define a first chamber 134 on a first side of the piston 118 and/or a second chamber 136 on a second side of the piston 118. In some examples, the cylinder housing 116a may define a fluid inlet 122a fluidly connected to the first chamber 134 and/or a fluid outlet 128a fluidly connected to the first chamber 134. In some examples, the cylinder housing 116a may define a second fluid inlet 122b fluidly connected to the second chamber 136 and/or the fluid outlet 128a fluidly connected to the second chamber 136. In some examples, the fluid inlet 122a may be fluidly connected to a first conduit 123a (e.g., a first tube) and the fluid outlet 128a may be fluidly connected to a second conduit 130a (e.g., a second tube). In some examples, the second fluid inlet 122b may be fluidly connected to a third conduit 123b (e.g., a third tube) and a second fluid outlet 128b may be fluidly connected to a fourth conduit 130b (e.g., a fourth tube).

In some examples, the apparatus 100 may comprise one or more valves (e.g., one or more one-way valves, a first valve 121a, a second valve 129a, a third valve 121b, a fourth valve 129b). In some examples, the first valve 121a (e.g., a first one-way valve) may be fluidly connected to the fluid inlet 122a and/or the first conduit 123a, wherein the first valve 121a may be configured to (i) allow a fluid to move from a fluid source (e.g., an ocean, a sea, a storage, etc.) to the first chamber 134, and/or (ii) prevent the fluid from flowing from the first chamber 134 to the fluid source. In some examples, the second valve 129a (e.g., a second one-way valve) may be fluidly connected to the fluid outlet 128a and/or the second conduit 130a, wherein the second valve 129a may be configured to (i) allow the fluid to move from the first chamber 134 to outside the first chamber 134, and/or (ii) prevent the fluid from flowing from outside the first chamber 134 to the first chamber 134. In some examples, the third valve 121b (e.g., a third one-way valve) may be fluidly connected to the second fluid inlet 122b and/or the third conduit 123b, wherein the third valve 121b may be configured to (i) allow a second fluid to move from the fluid source to the second chamber 136, and/or (ii) prevent the second fluid from flowing from the second chamber 136 to the fluid source. In some examples, the fourth valve 129b (e.g., a fourth one-way valve) may be fluidly connected to the second fluid outlet 128b and/or the fourth conduit 130b, wherein the fourth valve 129b may be configured to (i) allow the fluid to move from the first chamber 134 to outside the first chamber 134, and/or (ii) prevent the fluid from flowing from outside the first chamber 134 to the first chamber 134.

In some examples, the fluid source may comprise a fluid reservoir defining a fluid reservoir outlet. In an example, fluids from the fluid reservoir may flow from the fluid reservoir outlet to the fluid inlets defined by the cylinder housing 116a, wherein an elevation (e.g., a height) of the fluid reservoir outlet defined by the fluid reservoir may be greater than elevations (e.g., heights) of the fluid inlets defined by the cylinder housing 116a. In some examples, the fluid source may comprise at least a first portion of the body of water 101, wherein fluids from the body of water 101 may flow to the fluid inlets defined by the cylinder housing 116a.

In some examples, the piston 118 may be coupled (e.g., connected, attached, etc.) to the weighted structure 106. In some examples, the piston 118 may be coupled (e.g., connected, attached, etc.) to a beam 124a (e.g., a bar) of the frame 124 via the piston rod 120. In some examples, a combination of the piston 118 and the piston rod 120 may be coupled (e.g., connected, attached, etc.) to the weighted structure 106 via the frame 124.

In some examples, the cylinder assembly 116 may be placed (e.g., mounted) on one or more supports (e.g., a support 126) wherein the one or more supports may be placed (e.g., mounted) on one or more walls (e.g., a first wall 127a, a second wall 127b, etc.). In some examples, the first support column and/or the second support column 110 may be coupled (e.g., fixed) to the one or more supports and/or to the one or more walls. For example, the first support column may be coupled (e.g., fixed) to the support 126 and/or to the first wall 127a. For example, the second support column 110 may be coupled (e.g., fixed) to the support 126 and/or to the second wall 127b. In some examples, the one or more walls may be placed (e.g., mounted) on a foundation 112 (e.g., a base, a bed, a pedestal, etc.). Although FIGS. 1A-1D illustrate the cylinder assembly 116 and the cylinder housing 116a, any number of cylinder assemblies and cylinder housings are contemplated in the present disclosure. In some examples, the apparatus 100 may comprise one or more cylinder assemblies and/or the cylinder assembly 116 may comprise one or more cylinder housings.

In some examples, the one or more guide rails (e.g., the first guide rail 132c, the second guide rail 132d, the third guide rail 132a, the fourth guide rail 132b) may be coupled (e.g., fixed) to the support 126 and/or to the one or more walls. For example, the first guide rail 132c and/or the second guide rail 132d may be coupled (e.g., fixed) to the support 126 and/or to the first wall 127a. For examples, the third guide rail 132a and/or the fourth guide rail 132b may be coupled (e.g., fixed) to the support 126 and/or to the second wall 127b.

In some examples, the first wall 127a may comprise a first gate 103a (e.g., a first hole) configured to allow a portion of the body of water 101 (e.g., a portion of a sea, a portion of an ocean, a portion of untreated water, etc.) to move from a first region 104a to a second region 104b. In some examples, the second wall 127b may comprise a second gate 103b (e.g., a second hole) configured to allow a second portion of the body of water 101 (e.g., a second portion of a sea, a second portion of an ocean, a second portion of untreated water, etc.) to move from the second region 104b to a third region 104c. In some examples, the apparatus 100 may be placed in the second region 104b between the first wall 127a and the second wall 127b.

FIG. 1E illustrates a top view of the apparatus 100, in accordance with some embodiments. As shown in FIG. 1E, the first weighted structure support assembly (shown with reference number 107) is coupled to the first wall 127a and/or to the support 126. In FIG. 1E, the second weighted structure support assembly 108 is coupled to the second wall 127b and/or to the support 126.

FIGS. 1F-1K illustrate first cross-sectional views of the sequential stages of the operational cycle of the apparatus 100 during the rising and the falling of the body of water 101 (e.g., during the rising tide phase of the body of water 101 and the falling tide phase of the body of water 101), in accordance with some embodiments. The first cross-sectional views are taken along line A-A (shown in FIG. 1A). As shown in FIGS. 1F-1K, the first weighted structure support assembly 107 may comprise the first lock mechanism (shown with reference number 107a), the first release mechanism (shown with reference number 107b), the first connecting rod (shown with reference number 109a) and/or a first detent (not shown).

FIG. 1F illustrates a first cross-sectional view (taken along line A-A shown in FIG. 1A) of the apparatus 100, wherein the apparatus 100 is in the first stage of the operational cycle at the beginning of the rising of the body of water 101, in accordance with some embodiments. In some examples, the first stage may occur (i) when the buoyant body 102 (e.g., a center of gravity of the buoyant body 102 and/or a surface 101a of the body of water 101) reaches (e.g., arrives at, approaches, etc.) a first buoyant body elevation Z1 (e.g., a first buoyant body height), and/or (ii) when the weighted structure 106 (e.g., a center of gravity of the weighted structure 106) reaches (e.g., arrives at, approaches, etc.) a first weighted structure elevation Z2 (e.g., a first weighted structure height). In some examples, upward movement (e.g., movement towards an upward direction 103) of the body of water 101 may induce upward movement of the buoyant body 102 from the first buoyant body elevation Z1 to a second buoyant body elevation Z3 (e.g., a second buoyant body height). In some examples, the upward movement of the buoyant body 102 from the first buoyant body elevation Z1 to the second buoyant body elevation Z3 may induce upward movement of the weighted structure 106 from the first weighted structure elevation Z2 to a second weighted structure elevation Z4 (e.g., a second weighted structure height). In some examples, the upward movement of the weighted structure 106 from the first weighted structure elevation Z2 to the second weighted structure elevation Z4 may induce a first movement of the piston 118 in a first direction (e.g., the upward direction 103). For example, the upward movement of the weighted structure 106 from the first weighted structure elevation Z2 to the second weighted structure elevation Z4 may induce a first movement of the frame 124 in the first direction. Alternatively and/or additionally, the first movement of the frame 124 in the first direction may induce a first movement of the piston rod 120 in the first direction. Alternatively and/or additionally, the first movement of the piston rod 120 in the first direction may induce a first movement of the piston 118 in the first direction. In some examples, the first movement of the piston 118 may induce a transfer of a portion of the fluid (e.g., the body of water 101, a sea, an ocean, untreated water, etc.) from the fluid source (e.g., an ocean, a sea, a fluid source storage, etc.) into the first chamber 134 through the first conduit 123a, the first valve 121a and/or the fluid inlet 122a. The first movement of the piston 118 may create (e.g., generate) a vacuum in the first chamber 134. Alternatively and/or additionally, upon the creation of the vacuum in the first chamber 134 and/or the first movement of the piston 118, the portion of the fluid may enter the first chamber 134 through the first conduit 123a, the first valve 121a and/or the fluid inlet 122a. In some examples, the portion of the fluid may enter the first conduit 123a. After the portion of the fluid enters the first conduit 123a and reaches the first valve 121a, the first valve 121a may be activated and may allow the portion of the fluid transfer (e.g., flow) from the first conduit 123a to the fluid inlet 122a and/or to the first chamber 134. In some examples, after the portion of the fluid enters the fluid inlet 122a and/or the first chamber 134, the first valve 121a may prevent the portion of the fluid from flowing from the first chamber 134 and/or the fluid inlet 122a to the first conduit 123a. As shown in FIG. 1F, a first flow direction associated with the portion of the fluid flowing from the fluid source to the first chamber 134 is indicated by a first flow direction arrow 111.

In some examples, before performing (e.g., operating, occurring) the first stage of the operational cycle, the second chamber 136 may comprise an amount of a first fluid (e.g., an amount of the body of water 101, an amount of the sea, an amount of the ocean, an amount of untreated water, etc.). In some examples, the first movement of the piston 118 may create (e.g., generate) a first pressure in the second chamber 136. Alternatively and/or additionally, upon the creation of the first pressure in the second chamber 136 and/or the first movement of the piston 118, the amount of the first fluid may exit the second chamber 136 through the second fluid outlet 128b, the fourth valve 129b and/or the fourth conduit 130b. In some examples, the amount of the first fluid may enter the fourth valve 129b (e.g., may transfer from the second chamber 136 to the fourth valve 129b) via the second fluid outlet 128b. After the amount of the first fluid enters the fourth valve 129b, the fourth valve 129b may be activated and may allow the amount of the first fluid transfer (e.g., flow) from the second fluid outlet 128b to the fourth conduit 130b and/or out of the second chamber 136. In some examples, after the amount of the first fluid enters the fourth conduit 130b and/or out of the second chamber 136, the fourth valve 129b may prevent the amount of the first fluid from flowing from the fourth conduit 130b and/or out of the second chamber 136 to the second chamber 136. As shown in FIG. 1F, a second flow direction associated with the amount of the first fluid flowing from the second chamber 136 to outside the second chamber 136 is indicated by a second flow direction arrow 113. In some examples, the portion of the fluid may transfer to the first chamber 134 with a flow rate and the amount of the first fluid may transfer to outside the second chamber 136 with a first flow rate. In some examples, the flow rate may be equal to the first flow rate.

In some examples, in response to the weighted structure 106 reaching the second weighted structure elevation Z4, the first lock mechanism 107a and/or the second lock mechanism 108a may engage (e.g., hold) the weighted structure 106 at the second weighted structure elevation Z4 (e.g., proximal the second weighted structure elevation Z4).

FIG. 1G illustrates a second cross-sectional view (taken along line A-A shown in FIG. 1A) of the apparatus 100, wherein the apparatus 100 is between the first stage and the second stage of the operational cycle during the rising of the body of water 101, in accordance with some embodiments. As shown in FIG. 1G, the buoyant body 102 is between the first buoyant body elevation Z1 and the second buoyant body elevation Z3. In FIG. 1G, the weighted structure 106 is between the first weighted structure elevation Z2 and the second weighted structure elevation Z4.

FIG. 1H illustrates a third cross-sectional view (taken along line A-A shown in FIG. 1A) of the apparatus 100, wherein the apparatus 100 is in the second stage of the operational cycle at the end of the rising of the body of water 101 and/or at the beginning of the falling of the body of water 101, in accordance with some embodiments. In some examples, the second stage may occur (i) when the buoyant body 102 reaches (e.g., arrives at, approaches, etc.) the second buoyant body elevation Z3, and/or (ii) when the weighted structure 106 reaches (e.g., arrives at, approaches, etc.) the second weighted structure elevation Z4. In some examples, downward movement (e.g., movement towards a downward direction 105) of the body of water 101 may induce downward movement of the buoyant body 102 from the second buoyant body elevation Z3 to the first buoyant body elevation Z1.

FIG. 1I illustrates a fourth cross-sectional view (taken along line A-A shown in FIG. 1A) of the apparatus 100, wherein the apparatus 100 is in the third stage of the operational cycle approaching the end of the falling of the body of water 101, in accordance with some embodiments. In some examples, the third stage may occur (i) when the buoyant body 102 reaches (e.g., arrives at, approaches, etc.) the first buoyant body elevation Z1, and/or (ii) when the weighted structure 106 reaches (e.g., arrives at, approaches, etc.) the second weighted structure elevation Z4 (e.g., a first weighted structure height). In some examples, during the downward movement of the buoyant body 102 from the second buoyant body elevation Z3 to the first buoyant body elevation Z1, the buoyant body 102 may engage the first release mechanism 107b and/or the second release mechanism 108b. Alternatively and/or additionally, the engagement of the buoyant body 102 with the first release mechanism 107b and/or the second release mechanism 108b may disengage the first lock mechanism 107a and/or the second lock mechanism 108a from the weighted structure 106 to allow downward movement of the weighted structure 106 from the second weighted structure elevation Z4 to the first weighted structure elevation Z2. In some examples, the downward movement of the weighted structure 106 from the second weighted structure elevation Z4 to the first weighted structure elevation Z2 may induce a second movement of the piston 118 in a second direction (e.g., the downward direction 105). For example, the downward movement of the weighted structure 106 from the second weighted structure elevation Z4 to the first weighted structure elevation Z2 may induce a second movement of the frame 124 in the second direction. Alternatively and/or additionally, the second movement of the frame 124 in the second direction may induce a second movement of the piston rod 120 in the second direction. Alternatively and/or additionally, the second movement of the piston rod 120 in the second direction may induce the second movement of the piston 118 in the second direction.

In some examples, the second movement of the piston 118 may induce (i) a transfer of the portion of the fluid from the first chamber 134 to outside the first chamber 134 through the fluid outlet 128a, the second valve 129a and/or the second conduit 130a and/or (ii) a transfer of a second portion of the fluid from the fluid source into the second chamber 136 through the third conduit 123b, the third valve 121b and/or the second fluid inlet 122b. The second movement of the piston 118 may create (e.g., generate) (i) a pressure in the first chamber 134, and/or (ii) a second vacuum in the second chamber 136. Alternatively and/or additionally, upon the creation of the pressure in the first chamber 134 and the second movement of the piston 118, the portion of the fluid may exit the first chamber 134 through the fluid outlet 128a, the second valve 129a and/or the second conduit 130a. Alternatively and/or additionally, upon the creation of the second vacuum in the second chamber 136 and the second movement of the piston 118, the second portion of the fluid may enter the second chamber 136 through the third conduit 123b, the third valve 121b and/or the second fluid inlet 122b. In some examples, the second portion of the fluid may enter the third conduit 123b. After the second portion of the fluid enters the third conduit 123b and reaches the third valve 121b, the third valve 121b may be activated and may allow the second portion of the fluid transfer (e.g., flow) from the third conduit 123b to the second fluid inlet 122b and/or to the second chamber 136. In some examples, after the second portion of the fluid enters the second fluid inlet 122b and/or the second chamber 136, the third valve 121b may prevent the second portion of the fluid from flowing from the second chamber 136 and/or the second fluid inlet 122b to the third conduit 123b. As shown in FIG. 1I, a third flow direction associated with the second portion of the fluid flowing from the fluid source to the second chamber 136 is indicated by a third flow direction arrow 115 and a fourth flow direction associated with the portion of the fluid flowing from the first chamber 134 to outside the first chamber 134 is indicated by a fourth flow direction arrow 117. In some examples, the second portion of the fluid may transfer to the second chamber 136 with a second flow rate and the portion of the fluid may transfer to outside the first chamber 134 with a third flow rate. In some examples, the second flow rate may be equal to the third flow rate. In some examples, the second flow rate and the third flow rate may be greater than the flow rate and the first flow rate. Alternatively and/or additionally, the fluid enters and/or exits the cylinder housing 116a at different flow rates and/or different pressures.

FIG. 1J illustrates a fifth cross-sectional view (taken along line A-A shown in FIG. 1A) of the apparatus 100, wherein the apparatus 100 is between the third stage and the fourth stage of the operational cycle during the falling of the body of water 101, in accordance with some embodiments. As shown in FIG. 1J, the buoyant body 102 is between the second buoyant body elevation Z3 and the first buoyant body elevation Z1. In FIG. 1J, the weighted structure 106 is between the second weighted structure elevation Z4 and the first weighted structure elevation Z2.

FIG. 1K illustrates a sixth cross-sectional view (taken along line A-A shown in FIG. 1A) of the apparatus 100, wherein the apparatus 100 is in the fourth stage of the operational cycle at the end of the falling of the body of water 101 and/or at the beginning of the second rising of the body of water 101 (e.g., at the end of the falling of the body of water 101), in accordance with some embodiments. In some examples, the fourth stage may occur (i) when the buoyant body 102 reaches (e.g., arrives at, approaches, etc.) the first buoyant body elevation Z1, and/or (ii) when the weighted structure 106 reaches (e.g., arrives at, approaches, etc.) the first weighted structure elevation Z2.

In some examples, after the fourth stage of the operational cycle, a second operational cycle that is similar to (e.g., the same as) the operational cycle may start (e.g., occur). In some examples, the second operational cycle may comprise four stages including a fifth stage, a sixth stage, a seventh stage, and an eighth stage. The fifth stage of the second operational cycle may be similar to (e.g., the same as) the first stage of the operational cycle, the sixth stage of the second operational cycle may be similar to (e.g., the same as) the second stage of the operational cycle, the seventh stage of the second operational cycle may be similar to (e.g., the same as) the third stage of the operational cycle and/or the eighth stage of the second operational cycle may be similar to (e.g., the same as) the fourth stage of the operational cycle.

In some examples, second upward movement of the body of water 101 (e.g., starting the fifth stage) may induce second upward movement of the buoyant body 102 from the first buoyant body elevation Z1 to the second buoyant body elevation Z3. In some examples, the second upward movement of the buoyant body 102 from the first buoyant body elevation Z1 to the second buoyant body elevation Z3 may induce second upward movement of the weighted structure 106 from the first weighted structure elevation Z2 to the second weighted structure elevation Z4. In some examples, the second upward movement of the weighted structure 106 from the first weighted structure elevation Z2 to the second weighted structure elevation Z4 may induce a third movement of the piston 118 in the first direction. For example, the second upward movement of the weighted structure 106 from the first weighted structure elevation Z2 to the second weighted structure elevation Z4 may induce a third movement of the frame 124 in the first direction.

Alternatively and/or additionally, the third movement of the frame 124 in the first direction may induce a third movement of the piston rod 120 in the first direction. Alternatively and/or additionally, the third movement of the piston rod 120 in the first direction may induce the third movement of the piston 118 in the first direction. In some examples, the third movement of the piston 118 may induce (i) a transfer of a third portion of the fluid from the fluid source into the first chamber 134 through the first conduit 123a, the first valve 121a and/or the fluid inlet 122a, and/or (ii) a transfer of the second portion of the fluid outside the second chamber 136 through the second fluid outlet 128b, the fourth valve 129b and/or the fourth conduit 130b.

The third movement of the piston 118 may create (e.g., generate) a third vacuum in the first chamber 134 and a second pressure in the second chamber 136. Alternatively and/or additionally, upon the creation of the third vacuum in the first chamber 134 and/or the third movement of the piston 118, the third portion of the fluid may enter the first chamber 134 through the first conduit 123a, the first valve 121a and/or the fluid inlet 122a. Alternatively and/or additionally, upon the creation of the second pressure in the second chamber 136 and/or the third movement of the piston 118, the second portion of the fluid may exit the second chamber 136 through the second fluid outlet 128b, the fourth valve 129b and/or the fourth conduit 130b. In some examples, the third portion of the fluid may enter the first conduit 123a. After the third portion of the fluid enters the first conduit 123a and reaches the first valve 121a, the first valve 121a may be activated and may allow the third portion of the fluid transfer (e.g., flow) from the first conduit 123a to the fluid inlet 122a and/or to the first chamber 134. In some examples, after the third portion of the fluid enters the fluid inlet 122a and/or the first chamber 134, the first valve 121a may prevent the portion of the fluid from flowing from the first chamber 134 and/or the fluid inlet 122a to the first conduit 123a. As shown in FIG. 1K, a fifth flow direction associated with the third portion of the fluid flowing from the fluid source to the first chamber 134 is indicated by the first flow direction arrow 111 and a fifth flow direction associated with the second portion of the fluid flowing from the second chamber 136 to outside the second chamber 136 is indicated by the second flow direction arrow 113.

In some examples, the second portion of the fluid may transfer to outside the second chamber 136 with a fourth flow rate and the third portion of the fluid may transfer to the first chamber 134 with a fifth flow rate. In some examples, the fourth flow rate may be equal to the fifth flow rate. In some examples, the second flow rate and the third flow rate may be greater than the fourth flow rate and the fifth flow rate. In some examples, the flow rate and the first flow rate may be equal to the fourth flow rate and the fifth flow rate.

FIGS. 1L-1Q illustrate second cross-sectional views of the sequential stages of the operational cycle of the apparatus 100 during the rising and the falling of the body of water 101, in accordance with some embodiments. The second cross-sectional views are taken along line B-B.

FIG. 1L illustrates a seventh cross-sectional view (taken along line B-B shown in FIG. 1A) of the apparatus 100, wherein the apparatus 100 is in the first stage of the operational cycle at the beginning of the rising of the body of water 101, in accordance with some embodiments.

FIG. 1M illustrates an eighth cross-sectional view (taken along line B-B shown in FIG. 1A) of the apparatus 100, wherein the apparatus 100 is between the first stage and the second stage of the operational cycle during the rising of the body of water 101, in accordance with some embodiments.

FIG. 1N illustrates a ninth cross-sectional view (taken along line B-B shown in FIG. 1A) of the apparatus 100, wherein the apparatus 100 is in the second stage of the operational cycle at the end of the rising of the body of water 101 and/or at the beginning of the falling of the body of water 101, in accordance with some embodiments.

FIG. 1O illustrates a tenth cross-sectional view (taken along line B-B shown in FIG. 1A) of the apparatus 100, wherein the apparatus 100 is in the third stage of the operational cycle approaching the end of the falling of the body of water 101, in accordance with some embodiments.

FIG. 1P illustrates an eleventh cross-sectional view (taken along line B-B shown in FIG. 1A) of the apparatus 100, wherein the apparatus 100 is between the third stage and the fourth stage of the operational cycle during the falling of the body of water 101, in accordance with some embodiments.

FIG. 1Q illustrates a twelfth cross-sectional view (taken along line B-B shown in FIG. 1A) of the apparatus 100, wherein the apparatus 100 is in the fourth stage of the operational cycle at the end of the falling of the body of water 101 and/or at the beginning of the second rising of the body of water 101, in accordance with some embodiments.

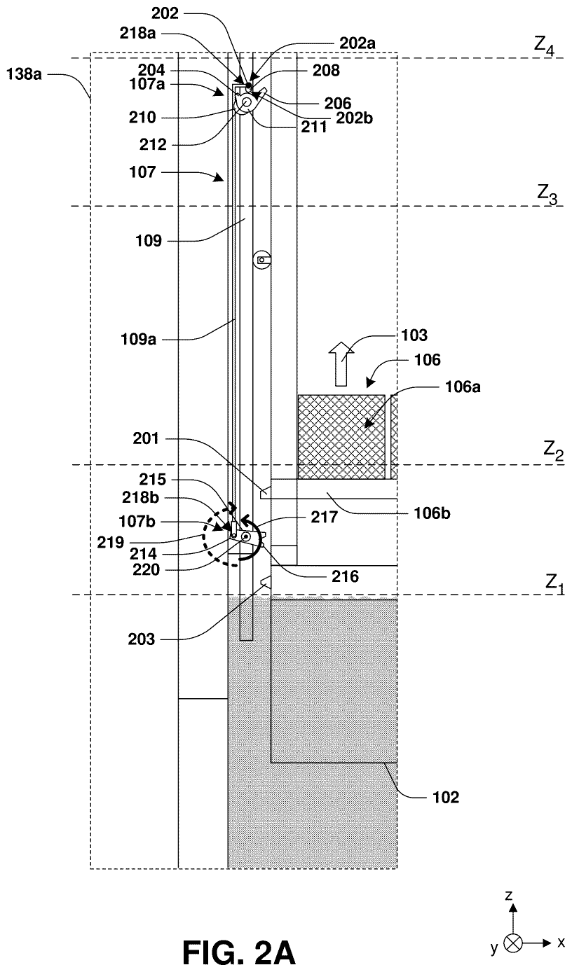

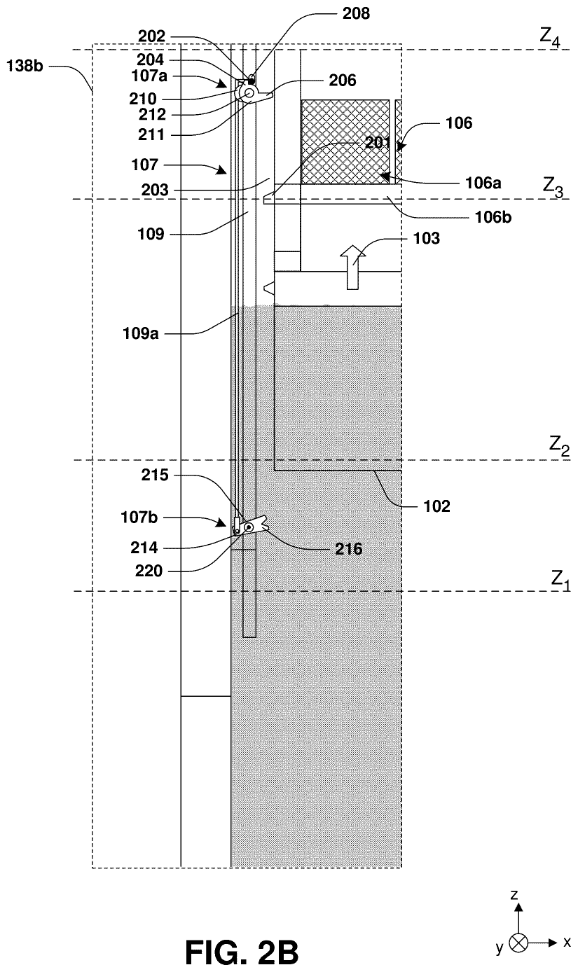

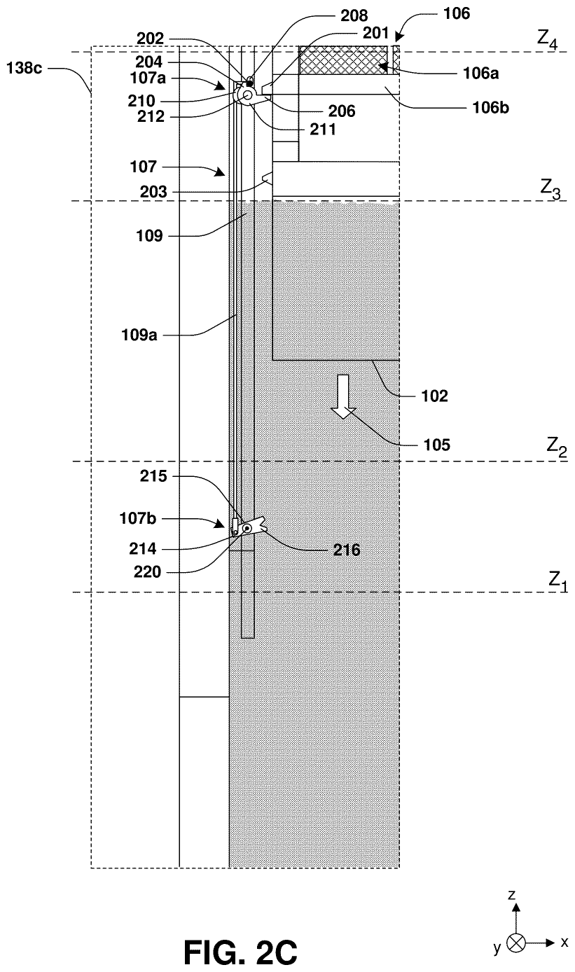

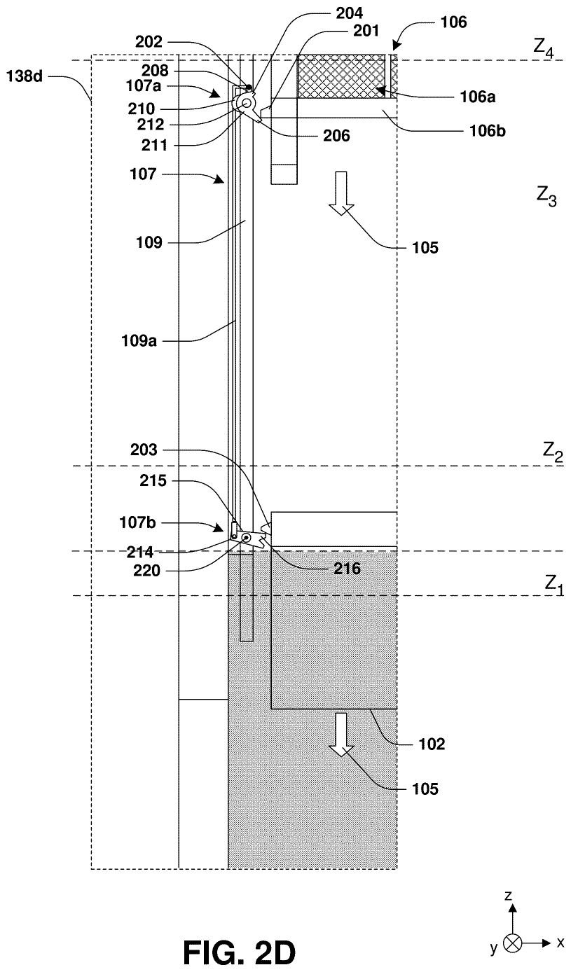

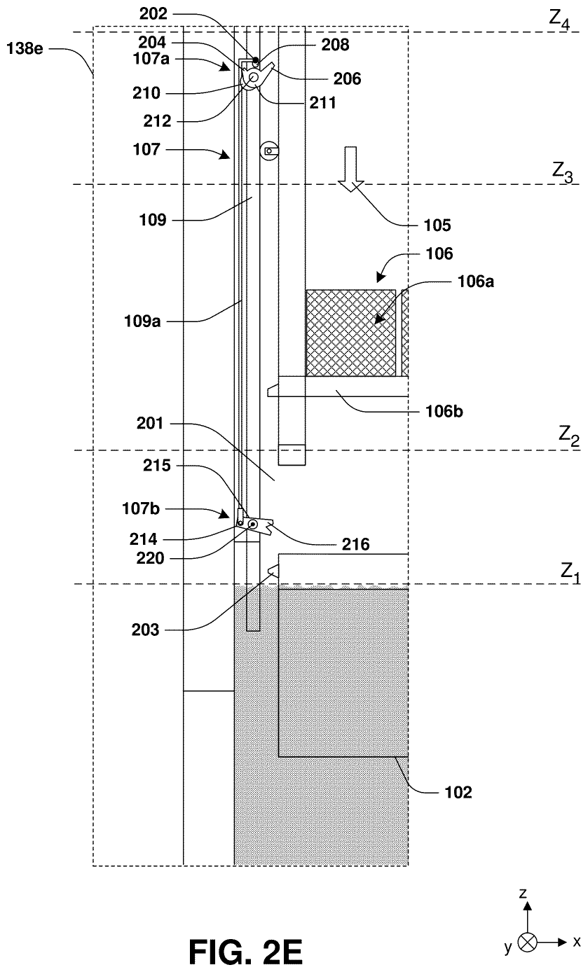

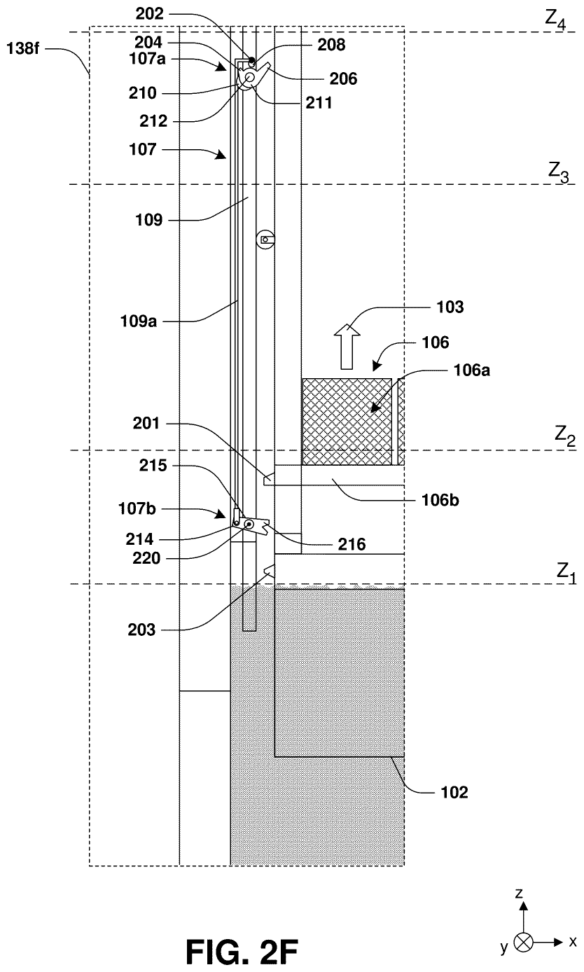

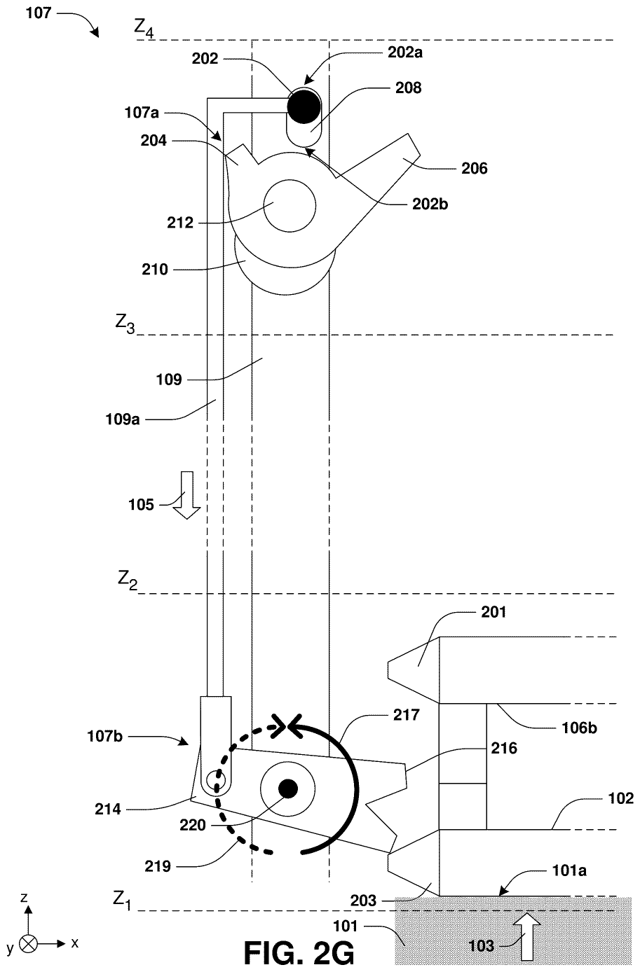

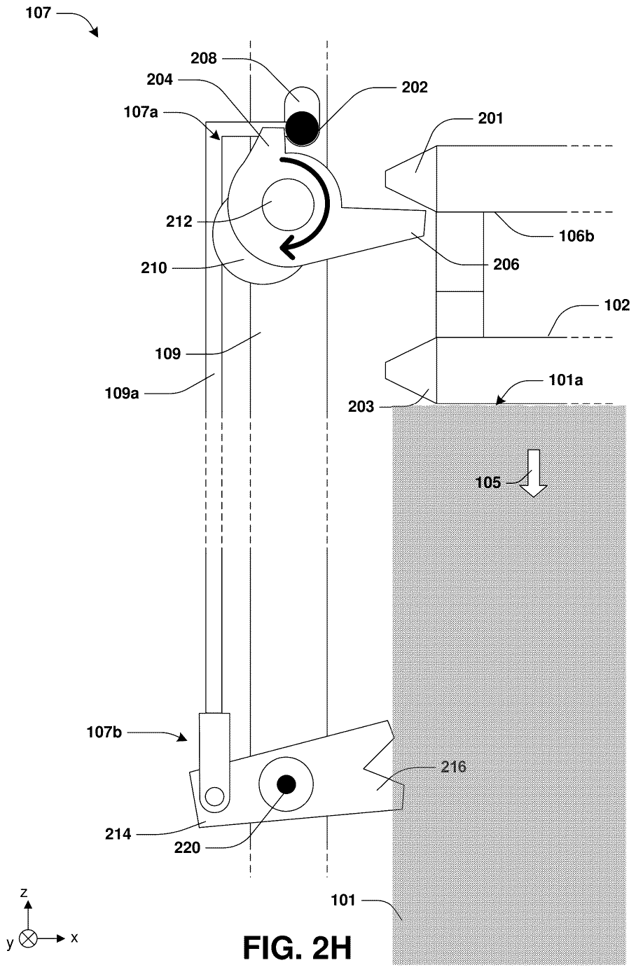

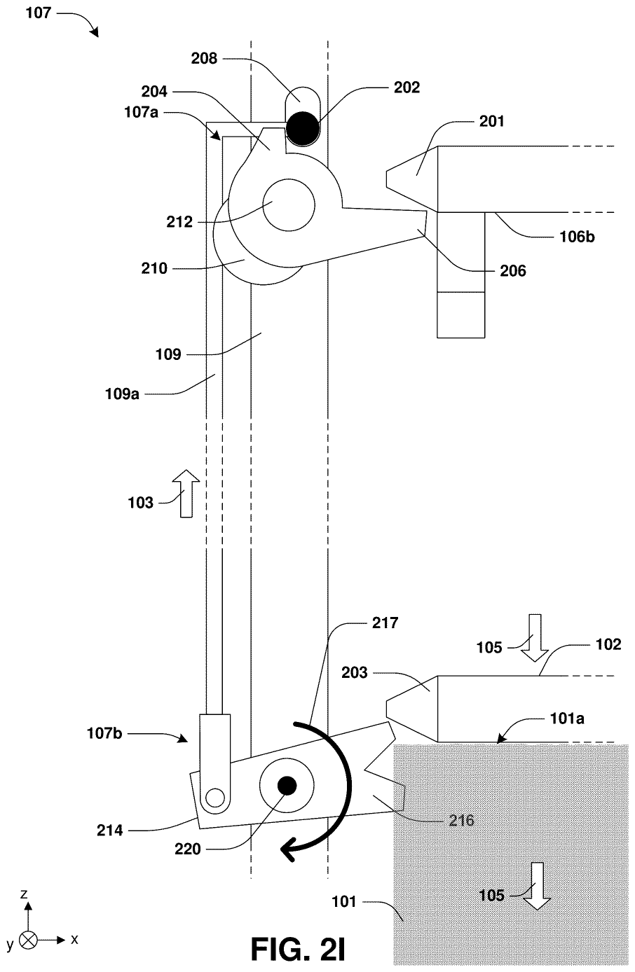

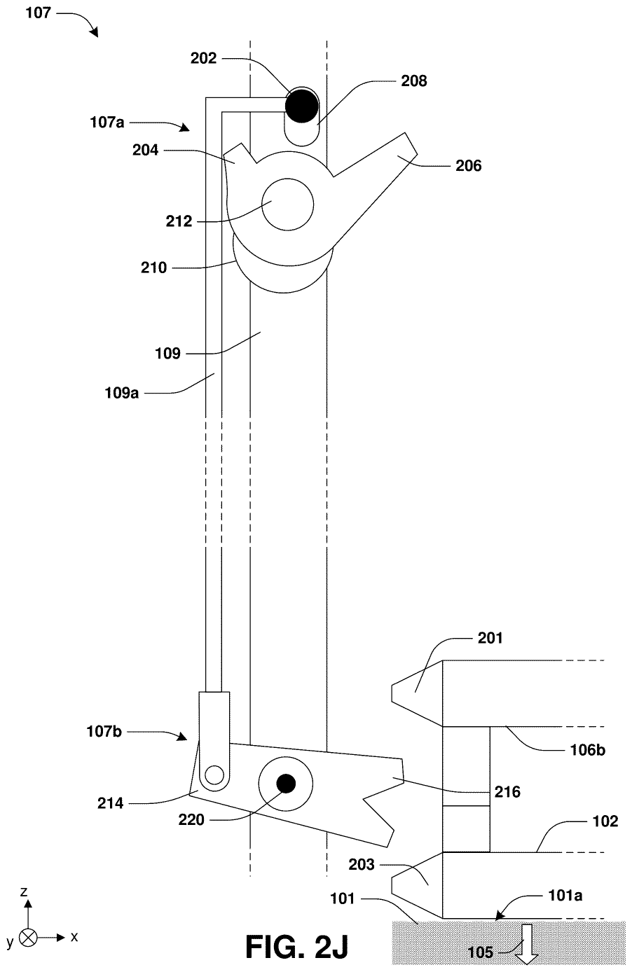

FIG. 2A illustrates an enlarged and/or detailed view of a section 138a of the apparatus 100 (shown in FIG. 1F), in accordance with some embodiments. In FIG. 2A, the first weighted structure support assembly 107 comprises the first lock mechanism 107a, the first release mechanism 107b, the first connecting rod 109a and/or the first detent (shown with reference number 202). In some examples, the first detent 202 may be coupled to a first end 218a of the first connecting rod 109a. In some examples, a second end 218b of the first connecting rod 109a may be pivotally coupled to a third end 214 of the first crank (shown with reference number 215). In some examples, the first detent 202 may be moveable within a first slot 208 (e.g., a first gap, a first groove, etc.) defined by the first support column (shown with reference number 109). In some examples, the first latch (shown with reference number 211) may comprise a first tongue 206 (e.g., a first holder, a first support, etc.) configured to support (e.g., hold) the weighted structure 106 at the second weighted structure elevation Z4. In some examples, the first latch 211 may comprise a second tongue 204 configured to lock the first lock mechanism 107a at one stage (e.g., the second stage of the operational cycle) of working the apparatus 100 and/or unlock the first lock mechanism 107a at another stage (e.g., the third stage of the operational cycle) of working the apparatus 100. In some examples, the first tongue 206 and the second tongue 204 may be connected to each other orthogonally.

In some examples, during the upward movement of the buoyant body 102 from the first buoyant body elevation Z1 to the second buoyant body elevation Z3, the first protrusion (shown with reference number 203) of the buoyant body 102 may engage the first crank 215 and/or a fourth end 216 of the first crank 215 to induce rotation of the first crank 215 around a first rotational direction 217 (e.g., a counterclockwise direction). Alternatively and/or additionally, the rotation of the first crank 215 around the first rotational direction 217 may induce movement of the first connecting rod 109a towards the downward direction 105, in a manner that may displace the first detent 202 from a first location 202a relative to the first slot 208 to a second location 202b (e.g., a location below the first location 202a) relative to the first slot 208. As shown in FIG. 2A, the first crank 215 is coupled to the first support column 109 via the first fulcrum (shown with reference number 220) and the first latch 211 is coupled to the first support column 109 via the second fulcrum (shown with reference number 212). In some examples, the first fulcrum 220 may allow the first crank 215 to rotate around the first rotational direction 217 and/or a second rotational direction 219 (e.g., a rotational direction opposite the first rotational direction 217, a clockwise direction). In some examples, the second fulcrum 212 may allow the first latch 211 to rotate around the first rotational direction 217 and/or the second rotational direction 219.

FIG. 2B illustrates an enlarged and/or detailed view of a section 138b of the apparatus 100 (shown in FIG. 1G), in accordance with some embodiments.

FIG. 2C illustrates an enlarged and/or detailed view of a section 138c of the apparatus 100 (shown in FIG. 1H), in accordance with some embodiments. In some examples, when the first detent 202 is at the second location 202b relative to the first slot 208, the first detent 202 may engage the second tongue 204 to inhibit (e.g., prevent) rotation of the first latch 211 around the second rotational direction 219 (e.g., the clockwise direction). In some examples, when the first detent 202 engages the second tongue 204, the first lock mechanism 107a may be activated and/or the first tongue 206 may be able to support (e.g., hold) the weighted structure 106 and/or the third protrusion (shown with reference number 201) of the support surface 106b. In some examples, a length of the first tongue 206 may be greater than a length of the second tongue 204.

FIG. 2D illustrates an enlarged and/or detailed view of a section 138d of the apparatus 100 (shown in FIG. 1I), in accordance with some embodiments. In some examples, during the downward movement of the buoyant body 102 from the second buoyant body elevation Z3 to the first buoyant body elevation Z1, the first protrusion 203 may engage the first crank 215 (e.g., the fourth end 216 of the first crank 215) to induce rotation of the first crank 215 around the second rotational direction 219. Alternatively and/or additionally, the rotation of the first crank 215 around the second rotational direction 219 may induce movement of the first connecting rod 109a towards the upward direction 103, in a manner that may displace the first detent 202 from the second location 202b relative to the first slot 208 to the first location 202a relative to the first slot 208. In some examples, when the first detent 202 is at the first location 202a relative to the first slot 208, the first detent 202 may disengage the second tongue 204 to allow rotation of the first latch 211 around the second rotational direction 219. In some examples, when the first detent 202 disengages the second tongue 204, the first lock mechanism 107a may be deactivated and/or the first tongue 206 may allow the weighted structure 106 and/or the third protrusion 201 of the support surface 106b to move towards the downward direction 105. In some examples, the first lock mechanism 107a may comprise a first counterweight 210 configured to return the first latch 211 from a rotational position that is offset from a neutral rotational position of the first latch 211 to the neutral rotational position of the first latch 211. For example, after the downward movement of the weighted structure 106, the third protrusion 201 may cause the first latch 211 to rotate around the second rotational direction 219. After the rotation of the first latch 211 around the second rotational direction 219, the first counterweight 210 may cause the first latch 211 to rotate around the first rotational direction 217 to return to the neutral rotational position of the first latch 211. In some examples, the second weighted structure support assembly 108 comprises all elements of the first weighted structure support assembly 107, whereby any action that may occur in the first weighted structure support assembly 107 may likewise occur in the second weighted structure support assembly 108.

FIG. 2E illustrates an enlarged and/or detailed view of a section 138e of the apparatus 100 (shown in FIG. 1J), in accordance with some embodiments.

FIG. 2F illustrates an enlarged and/or detailed view of a section 138f of the apparatus 100 (shown in FIG. 1K), in accordance with some embodiments. As shown in FIG. 2F, after the downward movement of the weighted structure 106, the weighted structure 106 reaches the buoyant body 102 and/or lies on the buoyant body 102.

FIG. 2G illustrates a schematic view of the first weighted structure support assembly 107 at the first stage of the operational cycle of the apparatus 100 (shown in FIG. 2A) at the beginning of the rising of the body of water 101, in accordance with some embodiments.

FIG. 2H illustrates a schematic view of the first weighted structure support assembly 107 at the second stage of the operational cycle of the apparatus 100 (shown in FIG. 2C) at the end of the rising of the body of water 101, in accordance with some embodiments.

FIG. 2I illustrates a schematic view of the first weighted structure support assembly 107 at the third stage of the operational cycle of the apparatus 100 (shown in FIG. 2D) approaching the end of the falling of the body of water 101, in accordance with some embodiments.

FIG. 2J illustrates a schematic view of the first weighted structure support assembly 107 at the fourth stage of the operational cycle of the apparatus 100 (shown in FIG. 2F) at the end of the falling of the body of water 101 and/or at the beginning of the second rising of the body of water 101, in accordance with some embodiments.

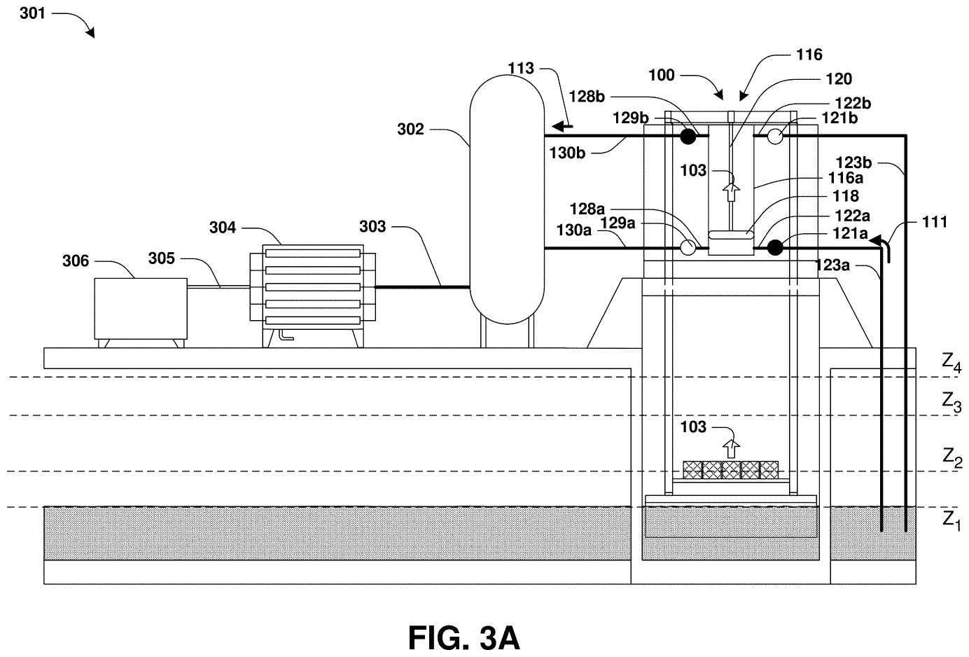

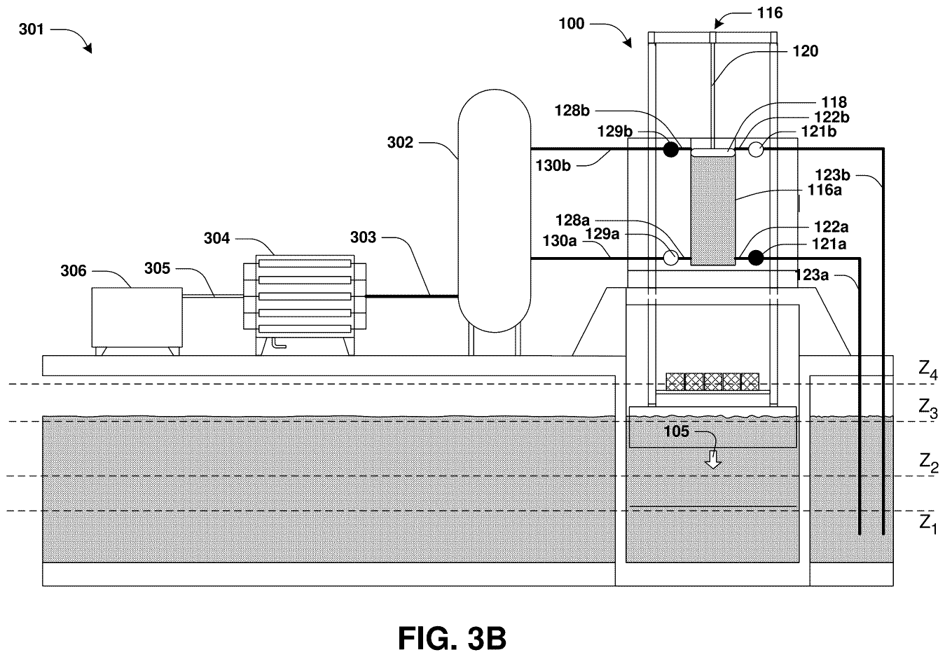

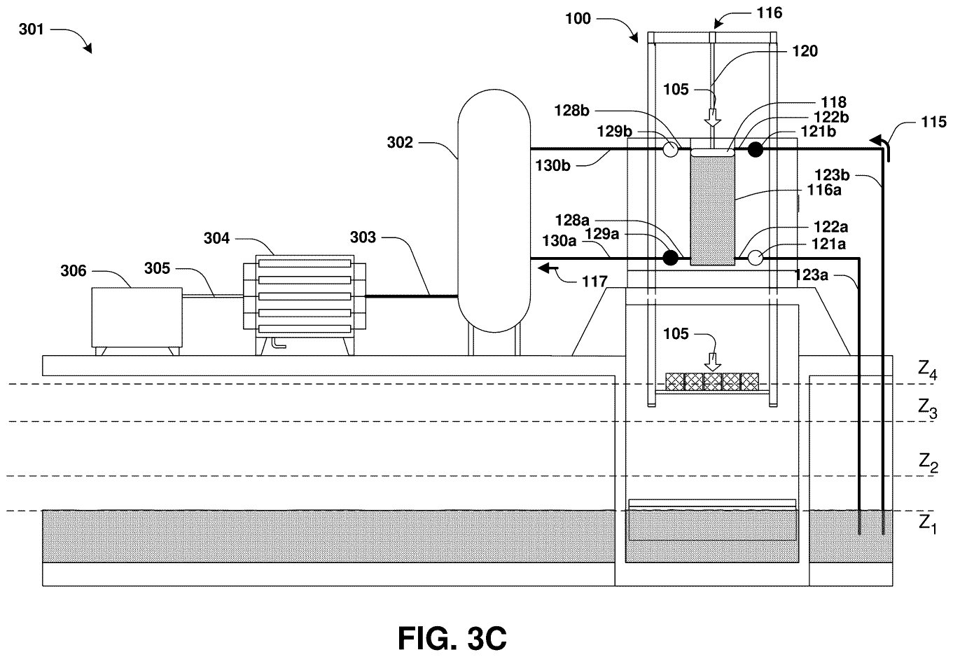

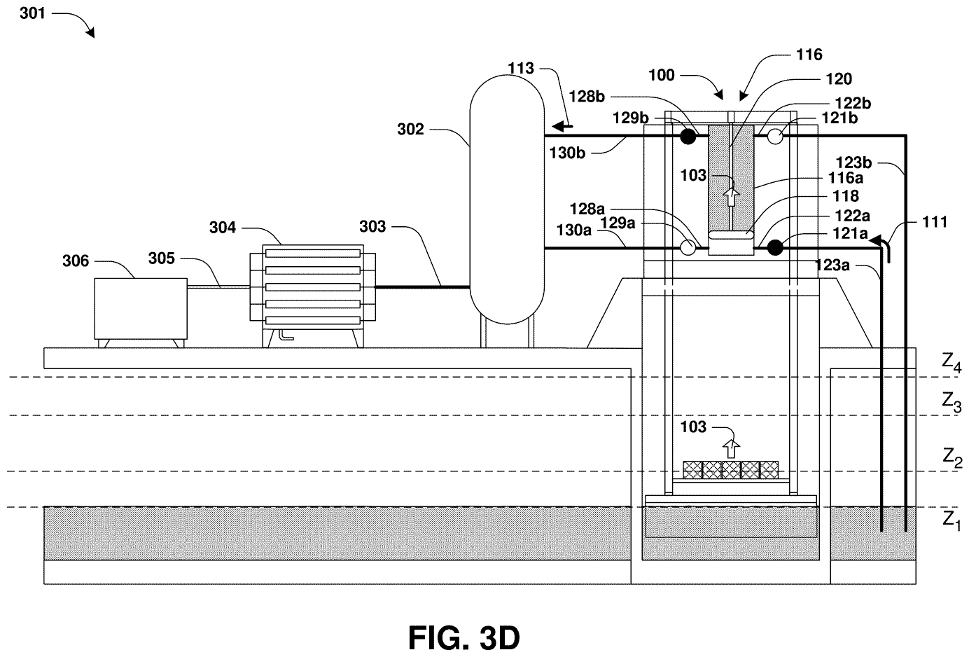

FIGS. 3A-3D illustrate a desalination system 301 comprising the apparatus 100, a buffer pressure tank 302, a membrane assembly 304 and a storage tank 306, in accordance with some embodiments. FIG. 3A illustrates the desalination system 301 when the apparatus 100 is in the first stage of the operational cycle at the beginning of the rising of the body of water 101. FIG. 3B illustrates the desalination system 301 when the apparatus 100 is in the second stage of the operational cycle at the end of the rising of the body of water 101 and/or at the beginning of the falling of the body of water 101. FIG. 3C illustrates the desalination system 301 when the apparatus 100 is in the third stage of the operational cycle approaching the end of the falling of the body of water 101. FIG. 3D illustrates the desalination system 301 when the apparatus 100 is in the fourth stage of the operational cycle at the end of the falling of the body of water 101 and/or at the beginning of the second rising of the body of water 101 (e.g., at the end of the falling of the body of water 101). As shown in FIGS. 3A-3D, the second conduit 130a and the fourth conduit 130b of the apparatus 100 are fluidly connected to the buffer pressure tank 302. In some examples, the fluids (e.g., the fluid, the first fluid, the second fluid, the third fluid, etc.) transferred from the cylinder housing 116a (e.g., from the first chamber 134 and the second chamber 136) to outside the cylinder housing 116a, may enter the buffer pressure tank 302. After the fluids entered the buffer pressure tank 302, the buffer pressure tank 302 may pressurize the fluids and/or may transfer the pressurized fluids to the membrane assembly 304 through one or more conduits (e.g., one or more pipes, one or more tubes, a conduit 303, etc.). In some examples, the desalination system 301 may be a reverse osmosis (RO) desalination system. In some examples, the desalination system 301 may comprise a multi-stage flash (MSF) distillation system, a multiple-effect distillation (MED) system, a membrane process system (e.g., electrodialysis system and/or membrane distillation system), a freezing desalination system, a capacitive deionization system and/or a forward osmosis system.

In some examples, the desalination system 301 may be a water purification system configured to utilize the membrane assembly 304 to remove dissolved salts and other impurities from saline or brackish water. As a result of the membrane assembly 304 removing the dissolved salts and other impurities from the saline or brackish water, fresh water is produced. In some examples, the membrane assembly 304 may transfer the fresh water to the storage tank 306 (e.g., water storage tank) through one or more second conduits (e.g., one or more second pipes, one or more second tubes, a conduit 305, etc.). In some examples, the salts obtained by the membrane assembly 304 may be stored. In some examples, the desalination system 301 may be positioned proximal coastal regions and/or may be disposed over a second body of water (e.g., a pool) to which the body of water 101 (e.g., an ocean, a sea, untreated water, etc.) may be introduced.

In some examples, the apparatus 100 (in the desalination system 301, for example) may not comprise the one or more weighted structure support assemblies and/or may not use the one or more weighted structure support assemblies in the stages of the operational cycles during the rising and falling of water levels of the body of water 101. Alternatively and/or additionally, velocity of upward movements of the body of water 101 (for example, during the rising tide phase) may be about equal to velocity of downward movements of the body of water 101 (for example, during the falling tide phase). Alternatively and/or additionally, velocity of movement of the buoyant body 102 in the upward direction 103 may be about equal to velocity of movement of the buoyant body 102 in the downward direction 105. Alternatively and/or additionally, velocity of movement of the piston 118 in the upward direction 103 may be about equal to velocity of movement of the piston 118 in the downward direction 105. Alternatively and/or additionally, the fluid enters and/or exits the cylinder housing 116a at about a constant flow rate and/or a constant pressure.

In some examples, the fluids (e.g., the fluid, the first fluid, the second fluid, the third fluid, etc.) transferred from the cylinder housing 116a (e.g., the first chamber 134 and the second chamber 136) to outside the cylinder housing 116a, may be conducted to a generator that is configured to generate electricity.

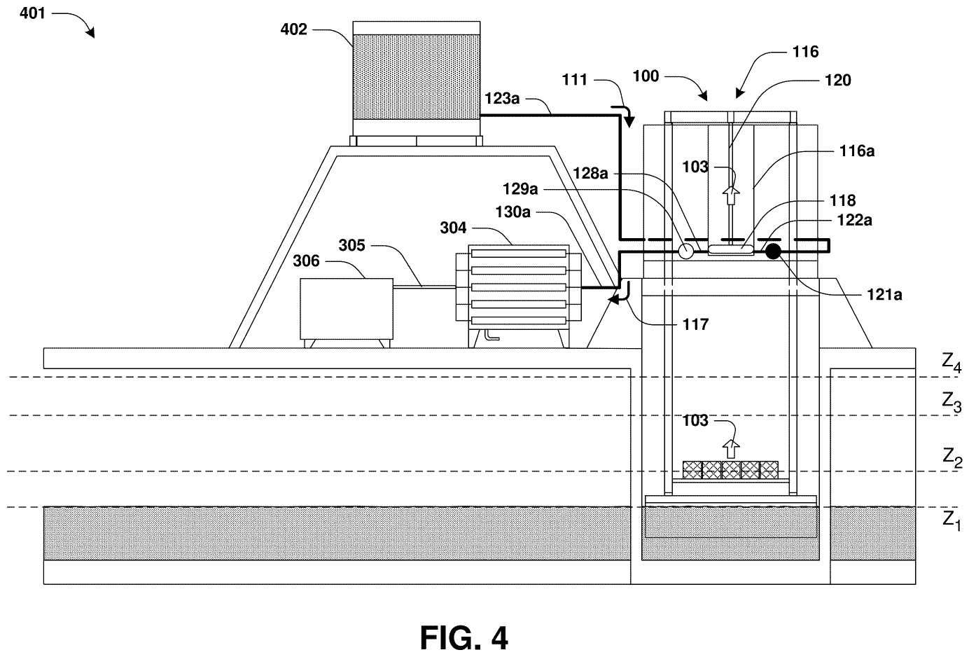

FIG. 4 illustrates a desalination system 401 comprising the apparatus 100, a fluid source storage tank 402, the membrane assembly 304 and the storage tank 306, in accordance with some embodiments. In an example, the apparatus 100 does not include the second fluid inlet 122b, the third valve 121b, the third conduit 123b, the second fluid outlet 128b, the fourth valve 129b and/or the fourth conduit 130b. As shown in FIG. 4, the second conduit 130a of the apparatus 100 is fluidly connected to the membrane assembly 304 and/or the first conduit 123a of the apparatus 100 is fluidly connected to the fluid source storage tank 402. In some examples, the fluids (e.g., the fluid, the first fluid, the second fluid, the third fluid, etc.) transferred from the cylinder housing 116a to outside the cylinder housing 116a, may enter the membrane assembly 304. In some examples, the desalination system 401 may be a second RO desalination system. In some examples, the desalination system 401 may be a second water purification system configured to utilize the membrane assembly 304 to remove dissolved salts and other impurities from saline or brackish water.

After transferring the fluids to the membrane assembly 304, the membrane assembly 304 may remove the dissolved salts and other impurities from the saline or brackish water to produce fresh water. In some examples, the membrane assembly 304 may transfer the fresh water to the storage tank 306 (e.g., water storage tank) through the one or more second conduits (e.g., the one or more second pipes, the one or more second tubes, the conduit 305, etc.). In some examples, the salts obtained by the membrane assembly 304 may be stored. In some examples, the desalination system 401 may be positioned proximal the coastal regions and/or may be disposed over the second body of water (e.g., the pool) to which the body of water 101 (e.g., an ocean, a sea, untreated water, etc.) may be introduced.

In some examples, during the upward movement of the weighted structure 106 from the first stage to the second stage, the first movement of the piston 118 in the upward direction 103 may induce a transfer of the portion of the fluid from the fluid source storage tank 402 into the cylinder housing 116a through the first conduit 123a, the first valve 121a and/or the fluid inlet 122a. The first movement of the piston 118 in the upward direction 103 may create a vacuum in the cylinder housing 116a. Alternatively and/or additionally, upon the creation of the vacuum in the cylinder housing 116a and/or the first movement of the piston 118 in the upward direction 103, the portion of the fluid may enter the cylinder housing 116a through the first conduit 123a, the first valve 121a and/or the fluid inlet 122a. In some examples, the portion of the fluid may enter the first conduit 123a from the fluid source storage tank 402. After the portion of the fluid enters the first conduit 123a and reaches the first valve 121a, the first valve 121a may be activated and may allow the portion of the fluid to transfer (e.g., flow) from the first conduit 123a to the fluid inlet 122a and/or to the cylinder housing 116a. In some examples, after the portion of the fluid enters the fluid inlet 122a and/or the cylinder housing 116a, the first valve 121a may prevent the portion of the fluid from flowing from the first chamber 134 and/or the fluid inlet 122a to the first conduit 123a. As shown in FIG. 4, the first flow direction associated with the portion of the fluid flowing from the fluid source storage tank 402 to the cylinder housing 116a is indicated by the first flow direction arrow 111. In some examples, during an interval (e.g., a time) between the second stage and the third stage, (i) the body of water 101 and/or the buoyant body 102 move downward (e.g., in the downward direction 105), (ii) the piston 118 remains fixed in its position (e.g., in higher position in the cylinder housing 116a), and/or (iii) the portion of the fluid may remain in the cylinder housing 116a. In some examples, during an interval (e.g., a time) between the third stage and the fourth stage, the second movement of the piston 118 (e.g., a movement of the piston 118 in the downward direction 105) caused by downward movement of the weighted structure 106 may create (e.g., generate) a pressure in the cylinder housing 116a. Alternatively and/or additionally, upon the creation of the pressure in the cylinder housing 116a, the portion of the fluid may exit the cylinder housing 116a through the fluid outlet 128a, the second valve 129a and/or the second conduit 130a. In some examples, the portion of the fluid, after transferring from the cylinder housing 116a to outside the cylinder housing 116a, may enter the membrane assembly 304. In some examples, during an interval (e.g., a time) between the fourth stage of the operational cycle and the fifth stage of the second operational cycle, the third movement of the piston 118 (e.g., a movement of the piston 118 in the upward direction 103) may induce a transfer of the second portion of the fluid from the fluid source storage tank 402 into the cylinder housing 116a through the first conduit 123a, the first valve 121a and/or the fluid inlet 122a.

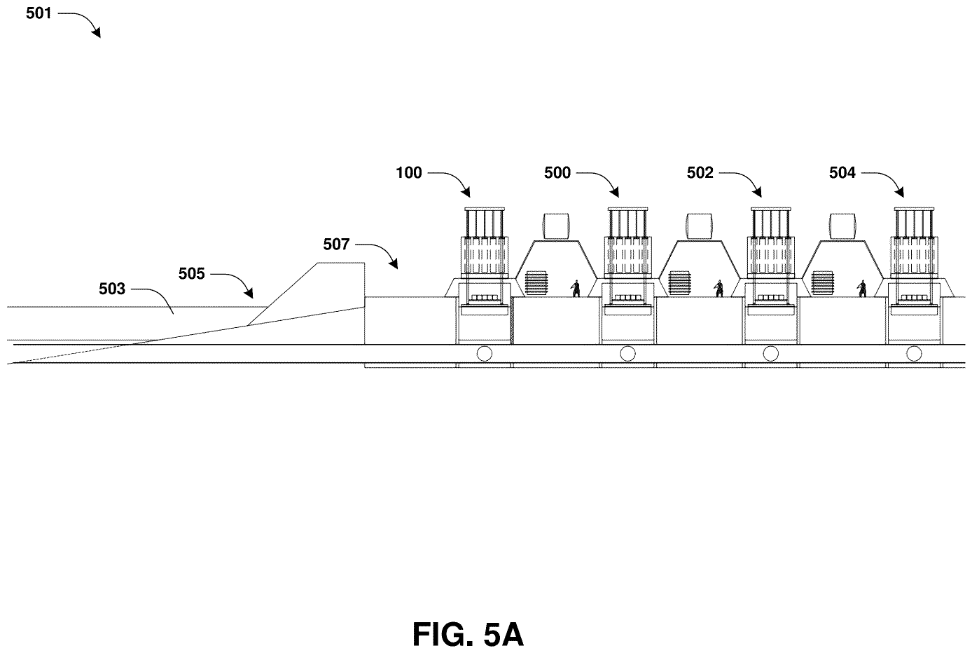

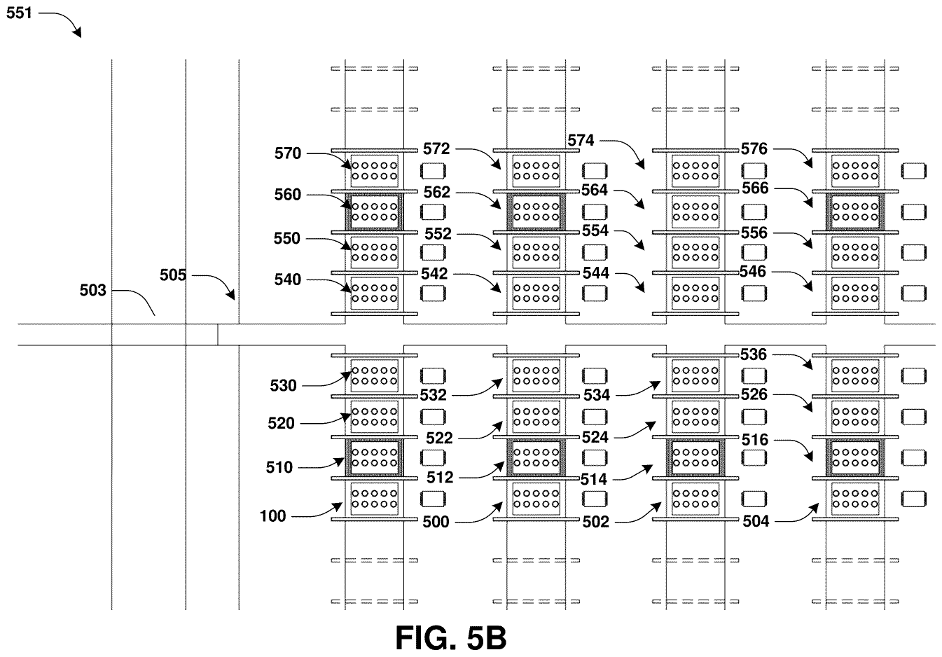

FIG. 5A illustrates a representation 501 of a side view of a plurality of tidal energy converter apparatuses (e.g., the apparatus 100, a second apparatus 500, a third apparatus 502, a fourth apparatus 504, a fifth apparatus (not shown), a sixth apparatus (not shown), a seventh apparatus (not shown), an eighth apparatus (not shown), a ninth apparatus (not shown), a tenth apparatus (not shown), an eleventh apparatus (not shown), a twelfth apparatus (not shown), a thirteenth apparatus (not shown), a fourteenth apparatus (not shown), a fifteenth apparatus (not shown), a sixteenth apparatus (not shown), a seventeenth apparatus (not shown), an eighteenth apparatus (not shown), a nineteenth apparatus (not shown), a twentieth apparatus (not shown), a twenty first apparatus (not shown), a twenty second apparatus (not shown), a twenty third apparatus (not shown), a twenty fourth apparatus (not shown), a twenty fifth apparatus (not shown), a twenty sixth apparatus (not shown), a twenty seventh apparatus (not shown), a twenty eighth apparatus (not shown), a twenty ninth apparatus (not shown), a thirtieth apparatus (not shown), a thirty first apparatus (not shown), a thirty second apparatus (not shown)), in accordance with some embodiments.

FIG. 5B illustrates a representation 551 of top view of the plurality of tidal energy converter apparatuses (e.g., the apparatus 100, the second apparatus 500, the third apparatus 502, the fourth apparatus 504, the fifth apparatus (shown with reference number 510), the sixth apparatus (shown with reference number 512), the seventh apparatus (shown with reference number 514), the eighth apparatus (shown with reference number 516), the ninth apparatus (shown with reference number 520), the tenth apparatus (shown with reference number 522), the eleventh apparatus (shown with reference number 524), the twelfth apparatus (shown with reference number 526), the thirteenth apparatus (shown with reference number 530), the fourteenth apparatus (shown with reference number 532), the fifteenth apparatus (shown with reference number 534), the sixteenth apparatus (shown with reference number 536), the seventeenth apparatus (shown with reference number 540), the eighteenth apparatus (shown with reference number 542), the nineteenth apparatus (shown with reference number 544), the twentieth apparatus (shown with reference number 546), the twenty first apparatus (shown with reference number 550), the twenty second apparatus (shown with reference number 552), the twenty third apparatus (shown with reference number 554), the twenty fourth apparatus (shown with reference number 556), the twenty fifth apparatus (shown with reference number 560), the twenty sixth apparatus (shown with reference number 562), the twenty seventh apparatus (shown with reference number 564), the twenty eighth apparatus (shown with reference number 566), the twenty ninth apparatus (shown with reference number 570), the thirtieth apparatus (shown with reference number 572), the thirty first apparatus (shown with reference number 574), the thirty second apparatus (shown with reference number 576)), in accordance with some embodiments.

As shown in FIGS. 5A-5B, the plurality of tidal energy converter apparatuses are installed on a coastal region 505. In some examples, the plurality of tidal energy converter apparatuses may be placed on a second body of water 507 (e.g., a pool) such that body of water 503 (e.g., ocean) may be conducted to the second body of water 507 through a plurality of gates. In some examples, the plurality of tidal energy converter apparatuses may be placed on open ocean coasts, bays, gulfs, estuaries, tidal inlets and lagoons, river mouths affected by tides, channel with strong tidal currents, harbors, ports, intertidal zones and/or any regions subject to tidal influence.

In some examples, an apparatus is provided. The apparatus includes a buoyant body, a weighted structure, a weighted structure support assembly and a cylinder assembly. The buoyant body is configured to float on a body of water. The weighted structure support assembly includes a lock mechanism and a release mechanism. In some examples, the cylinder assembly includes a cylinder housing and a piston in the cylinder housing. The cylinder housing defines a first chamber on a first side of the piston and a second chamber on a second side of the piston. The cylinder housing defines a fluid inlet fluidly connected to the first chamber and a fluid outlet fluidly connected to the first chamber. The piston is coupled to the weighted structure. Upward movement of a surface of the body of water induces upward movement of the buoyant body from a first buoyant body elevation to a second buoyant body elevation. The upward movement of the buoyant body from the first buoyant body elevation to the second buoyant body elevation induces upward movement of the weighted structure from a first weighted structure elevation to a second weighted structure elevation. The upward movement of the weighted structure from the first weighted structure elevation to the second weighted structure elevation induces a first movement of the piston in a first direction. The first movement of the piston induces transfer of a fluid from a fluid source into the first chamber through the fluid inlet. The lock mechanism engages the weighted structure to support the weighted structure at the second weighted structure elevation in response to the weighted structure reaching the second weighted structure elevation. Downward movement of the surface of the body of water induces downward movement of the buoyant body from the second buoyant body elevation to the first buoyant body elevation. During the downward movement of the buoyant body from the second buoyant body elevation to the first buoyant body elevation, the buoyant body engages the release mechanism. The engagement of the buoyant body with the release mechanism disengages the lock mechanism from the weighted structure to allow downward movement of the weighted structure from the second weighted structure elevation to the first weighted structure elevation. The downward movement of the weighted structure induces second movement of the piston in a second direction different than the first direction. The second movement of the piston induces transfer of the fluid from the first chamber to outside the first chamber through the fluid outlet.

In some examples, the cylinder housing defines a second fluid inlet fluidly connected to the second chamber and a second fluid outlet fluidly connected to the second chamber. The second movement of the piston induced by the downward movement of the weighted structure induces transfer of a second fluid from the fluid source into the second chamber through the second fluid inlet. Second upward movement of the surface of the body of water induces second upward movement of the buoyant body from the first buoyant body elevation to the second buoyant body elevation. The second upward movement of the buoyant body from the first buoyant body elevation to the second buoyant body elevation induces second upward movement of the weighted structure from the first weighted structure elevation to the second weighted structure elevation. The second upward movement of the weighted structure from the first weighted structure elevation to the second weighted structure elevation induces third movement of the piston in the first direction. The third movement of the piston induces transfer of the second fluid from the second chamber to outside the second chamber through the second fluid outlet and transfer of a third fluid from the fluid source into the first chamber through the fluid inlet.

In some examples, the release mechanism of the weighted structure support assembly comprises a crank coupled to a support column via a first fulcrum. The lock mechanism of the weighted structure support assembly comprises a latch coupled to the support column via a second fulcrum.

In some examples, the weighted structure support assembly includes a connecting rod and a detent coupled to a first portion of the connecting rod. The crank is pivotally coupled to a second portion of the connecting rod. The detent is moveable within a slot defined by the support column.

In some examples, the buoyant body includes a protrusion. During the upward movement of the buoyant body from the first buoyant body elevation to the second buoyant body elevation, the protrusion engages the crank to induce rotation of the crank around a first rotational direction. The rotation of the crank around the first rotational direction induces movement, of the connecting rod, that displaces the detent from a first location relative to the slot to a second location relative to the slot.

In some examples, the latch comprises a first tongue configured to support the weighted structure at the second weighted structure elevation and a second tongue.

In some examples, when the detent is at the second location relative to the slot, the detent engages the second tongue to inhibit rotation of the latch around a second rotational direction.

In some examples, a length of the first tongue is greater than a length of the second tongue.

In some examples, the lock mechanism comprises a counterweight configured to return the latch from a rotational position that is offset from a neutral rotational position of the latch to the neutral rotational position of the latch.

In some examples, a first flow rate with which the fluid is transferred from the first chamber to outside the first chamber through the fluid outlet is greater than a second flow rate with which the second fluid is transferred from the second chamber to outside the second chamber through the second fluid outlet.

In some examples, one or more conduits configured to conduct the fluid from the first chamber to a reverse osmosis (RO) desalination system.

In some examples, one or more conduits configured to conduct the fluid from the first chamber to a generator.

In some examples, a mass of the weighted structure is based upon a chamber volume associated with the cylinder housing.

In some examples, the fluid source comprises a fluid reservoir defining a fluid reservoir outlet. Fluid from the fluid reservoir flows from the fluid reservoir outlet to the fluid inlet defined by the cylinder housing through one or more conduits. An elevation of the fluid reservoir outlet defined by the fluid reservoir is greater than an elevation of the fluid inlet defined by the cylinder housing.

In some examples, the fluid source comprises at least a portion of the body of water. Fluid from the body of water flows to the fluid inlet defined by the cylinder housing through one or more conduits.

In some examples, an apparatus is provided. The apparatus includes a buoyant body and a cylinder assembly. The buoyant body is configured to float on a body of water. The cylinder assembly includes a cylinder housing and a piston in the cylinder housing.

In some examples, the cylinder housing defines a first chamber on a first side of the piston and a second chamber on a second side of the piston. The cylinder housing defines a fluid inlet connected to the first chamber and a fluid outlet connected to the first chamber. The piston is coupled to the buoyant body. Upward movement of the buoyant body during a rising tide phase of the body of water induces a first movement of the piston in a first direction. The first movement of the piston induces transfer of a fluid from a fluid source into the first chamber through the fluid inlet. Downward movement of the buoyant body during a falling tide phase of the body of water induces second movement of the piston in a second direction different than the first direction. The second movement of the piston induces transfer of the fluid from the first chamber to outside the first chamber through the fluid outlet.

In some examples, the cylinder housing defines a second fluid inlet connected to the second chamber and a second fluid outlet connected to the second chamber. The second movement of the piston induced by the downward movement of the buoyant body during the falling tide phase of the body of water induces transfer of a second fluid from the fluid source into the second chamber through the second fluid inlet. Second upward movement of the buoyant body during a second rising tide phase of the body of water after the falling tide phase induces third movement of the piston in the first direction. The third movement of the piston induces transfer of the second fluid from the second chamber to outside the second chamber through the second fluid outlet and transfer of a third fluid from the fluid source into the first chamber through the fluid inlet.

In some examples, the apparatus includes a buffer pressure tank, one or more first conduits, one or more second conduits and one or more third conduits. The one or more first conduits are configured to conduct the fluid from the first chamber to the buffer pressure tank. The one or more second conduits are configured to conduct the second fluid from the second chamber to the buffer pressure tank, wherein the buffer pressure tank is configured to produce a stream of pressurized fluid using at least one of the fluid or the second fluid. The one or more third conduits are configured to conduct the stream of pressurized fluid from the buffer pressure tank to a reverse osmosis (RO) desalination system

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments and/or examples are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment and/or example provided herein. Also, it will be understood that not all operations are necessary in some embodiments and/or examples.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An apparatus, comprising:
a buoyant body configured to float on a body of water;
a weighted structure;
a weighted structure support assembly comprising a lock mechanism and a release mechanism; and
a cylinder assembly comprising:
a cylinder housing; and
a piston in the cylinder housing, wherein:
the cylinder housing defines a first chamber on a first side of the piston and a second chamber on a second side of the piston;
the cylinder housing defines a fluid inlet fluidly connected to the first chamber and a fluid outlet fluidly connected to the first chamber;
the piston is coupled to the weighted structure;
upward movement of a surface of the body of water induces upward movement of the buoyant body from a first buoyant body elevation to a second buoyant body elevation;
the upward movement of the buoyant body from the first buoyant body elevation to the second buoyant body elevation induces upward movement of the weighted structure from a first weighted structure elevation to a second weighted structure elevation;
the upward movement of the weighted structure from the first weighted structure elevation to the second weighted structure elevation induces a first movement of the piston in a first direction;
the first movement of the piston induces transfer of a fluid from a fluid source into the first chamber through the fluid inlet;
the lock mechanism engages the weighted structure to support the weighted structure at the second weighted structure elevation in response to the weighted structure reaching the second weighted structure elevation;
downward movement of the surface of the body of water induces downward movement of the buoyant body from the second buoyant body elevation to the first buoyant body elevation;
during the downward movement of the buoyant body from the second buoyant body elevation to the first buoyant body elevation, the buoyant body engages the release mechanism;
the engagement of the buoyant body with the release mechanism disengages the lock mechanism from the weighted structure to allow downward movement of the weighted structure from the second weighted structure elevation to the first weighted structure elevation;
the downward movement of the weighted structure induces second movement of the piston in a second direction different than the first direction; and
the second movement of the piston induces transfer of the fluid from the first chamber to outside the first chamber through the fluid outlet.

2. The apparatus of claim 1, wherein:
the cylinder housing defines a second fluid inlet fluidly connected to the second chamber and a second fluid outlet fluidly connected to the second chamber;
the second movement of the piston induced by the downward movement of the weighted structure induces transfer of a second fluid from the fluid source into the second chamber through the second fluid inlet;
second upward movement of the surface of the body of water induces second upward movement of the buoyant body from the first buoyant body elevation to the second buoyant body elevation;
the second upward movement of the buoyant body from the first buoyant body elevation to the second buoyant body elevation induces second upward movement of the weighted structure from the first weighted structure elevation to the second weighted structure elevation;
the second upward movement of the weighted structure from the first weighted structure elevation to the second weighted structure elevation induces third movement of the piston in the first direction; and
the third movement of the piston induces:
transfer of the second fluid from the second chamber to outside the second chamber through the second fluid outlet; and
transfer of a third fluid from the fluid source into the first chamber through the fluid inlet.

3. The apparatus of claim 1, wherein:
the release mechanism of the weighted structure support assembly comprises a crank coupled to a support column via a first fulcrum; and
the lock mechanism of the weighted structure support assembly comprises a latch coupled to the support column via a second fulcrum.

4. The apparatus of claim 3, wherein:
the weighted structure support assembly comprises:
a connecting rod; and
a detent coupled to a first portion of the connecting rod;
the crank is pivotally coupled to a second portion of the connecting rod; and
the detent is moveable within a slot defined by the support column.

5. The apparatus of claim 4, wherein:
the buoyant body comprises a protrusion;
during the upward movement of the buoyant body from the first buoyant body elevation to the second buoyant body elevation, the protrusion engages the crank to induce rotation of the crank around a first rotational direction; and
the rotation of the crank around the first rotational direction induces movement, of the connecting rod, that displaces the detent from a first location relative to the slot to a second location relative to the slot.

6. The apparatus of claim 5, wherein:
the latch comprises a first tongue configured to support the weighted structure at the second weighted structure elevation and a second tongue.

7. The apparatus of claim 6, wherein:
when the detent is at the second location relative to the slot, the detent engages the second tongue to inhibit rotation of the latch around a second rotational direction.

8. The apparatus of claim 7, wherein:
a length of the first tongue is greater than a length of the second tongue.

9. The apparatus of claim 7, wherein:
the lock mechanism comprises a counterweight configured to return the latch from a rotational position that is offset from a neutral rotational position of the latch to the neutral rotational position of the latch.

10. The apparatus of claim 2, wherein:
a first flow rate with which the fluid is transferred from the first chamber to outside the first chamber through the fluid outlet is greater than a second flow rate with which the second fluid is transferred from the second chamber to outside the second chamber through the second fluid outlet.

11. The apparatus of claim 1, comprising:
one or more conduits configured to conduct the fluid from the first chamber to a reverse osmosis (RO) desalination system.

12. The apparatus of claim 1, comprising:
one or more conduits configured to conduct the fluid from the first chamber to a generator.

13. The apparatus of claim 1, wherein:
a mass of the weighted structure is based upon a chamber volume associated with the cylinder housing.

14. The apparatus of claim 1, wherein:
the fluid source comprises a fluid reservoir defining a fluid reservoir outlet;
fluid from the fluid reservoir flows from the fluid reservoir outlet to the fluid inlet defined by the cylinder housing through one or more conduits; and
an elevation of the fluid reservoir outlet defined by the fluid reservoir is greater than an elevation of the fluid inlet defined by the cylinder housing.

15. The apparatus of claim 1, wherein:
the fluid source comprises at least a portion of the body of water; and
fluid from the body of water flows to the fluid inlet defined by the cylinder housing through one or more conduits.

16. An apparatus, comprising:
a buoyant body configured to float on a body of water; and
a cylinder assembly comprising:
a cylinder housing; and
a piston in the cylinder housing, wherein:
the cylinder housing defines a first chamber on a first side of the piston and a second chamber on a second side of the piston;
the cylinder housing defines a fluid inlet connected to the first chamber and a fluid outlet connected to the first chamber;
the piston is coupled to the buoyant body;
upward movement of the buoyant body during a rising tide phase of the body of water induces a first movement of the piston in a first direction;
the first movement of the piston induces transfer of a fluid from a fluid source into the first chamber through the fluid inlet;
downward movement of the buoyant body during a falling tide phase of the body of water induces second movement of the piston in a second direction different than the first direction; and
the second movement of the piston induces transfer of the fluid from the first chamber to outside the first chamber through the fluid outlet.

17. The apparatus of claim 16, wherein:
the cylinder housing defines a second fluid inlet connected to the second chamber and a second fluid outlet connected to the second chamber;
the second movement of the piston induced by the downward movement of the buoyant body during the falling tide phase of the body of water induces transfer of a second fluid from the fluid source into the second chamber through the second fluid inlet;
second upward movement of the buoyant body during a second rising tide phase of the body of water after the falling tide phase induces third movement of the piston in the first direction; and
the third movement of the piston induces:
transfer of the second fluid from the second chamber to outside the second chamber through the second fluid outlet; and
transfer of a third fluid from the fluid source into the first chamber through the fluid inlet.

18. The apparatus of claim 17, comprising:
a buffer pressure tank;
one or more first conduits configured to conduct the fluid from the first chamber to the buffer pressure tank;
one or more second conduits configured to conduct the second fluid from the second chamber to the buffer pressure tank, wherein the buffer pressure tank is configured to produce a stream of pressurized fluid using at least one of the fluid or the second fluid; and
one or more third conduits configured to conduct the stream of pressurized fluid from the buffer pressure tank to a reverse osmosis (RO) desalination system.

19. An apparatus, comprising:
a buoyant body configured to float on a body of water;
a weighted structure;
a weighted structure support assembly comprising a lock mechanism and a release mechanism; and
a cylinder assembly comprising:
a cylinder housing; and
a piston in the cylinder housing, wherein:
the cylinder housing defines a first chamber on a first side of the piston and a second chamber on a second side of the piston;
the cylinder housing defines a fluid inlet fluidly connected to the first chamber and a fluid outlet fluidly connected to the first chamber;
the piston is coupled to the weighted structure;
upward movement of a surface of the body of water associated with a rising tide phase of the body of water induces upward movement of the buoyant body from a first buoyant body elevation to a second buoyant body elevation;
the upward movement of the buoyant body from the first buoyant body elevation to the second buoyant body elevation induces upward movement of the weighted structure from a first weighted structure elevation to a second weighted structure elevation;
the upward movement of the weighted structure from the first weighted structure elevation to the second weighted structure elevation induces a first movement of the piston in a first direction;
the first movement of the piston induces transfer of a fluid from a fluid source into the first chamber through the fluid inlet;
the lock mechanism engages the weighted structure to support the weighted structure at the second weighted structure elevation in response to the weighted structure reaching the second weighted structure elevation;
downward movement of the surface of the body of water associated with a falling tide phase of the body of water induces downward movement of the buoyant body from the second buoyant body elevation to the first buoyant body elevation;
during the downward movement of the buoyant body from the second buoyant body elevation to the first buoyant body elevation, the buoyant body engages the release mechanism;
the engagement of the buoyant body with the release mechanism disengages the lock mechanism from the weighted structure to allow downward movement of the weighted structure from the second weighted structure elevation to the first weighted structure elevation;
the downward movement of the weighted structure induces a second movement of the piston in a second direction different than the first direction; and
the second movement of the piston induces transfer of the fluid from the first chamber to outside the first chamber through the fluid outlet.

20. The apparatus of claim 19, wherein:
the cylinder housing defines a second fluid inlet fluidly connected to the second chamber and a second fluid outlet fluidly connected to the second chamber;
the second movement of the piston induced by the downward movement of the weighted structure induces transfer of a second fluid from the fluid source into the second chamber through the second fluid inlet;
second upward movement of the surface of the body of water induces second upward movement of the buoyant body from the first buoyant body elevation to the second buoyant body elevation;
the second upward movement of the buoyant body from the first buoyant body elevation to the second buoyant body elevation induces second upward movement of the weighted structure from the first weighted structure elevation to the second weighted structure elevation;
the second upward movement of the weighted structure from the first weighted structure elevation to the second weighted structure elevation induces third movement of the piston in the first direction; and
the third movement of the piston induces:
transfer of the second fluid from the second chamber to outside the second chamber through the second fluid outlet; and
transfer of a third fluid from the fluid source into the first chamber through the fluid inlet.
